(19) United States
(12) Patent Application Publication
(10) Pub. No.: US 2026/0325962 A1
(43) Pub. Date: Oct. 22, 2026

(54) NON-TRANSITORY COMPUTER READABLE MEDIUM, INFORMATION PROCESSING METHOD, INFORM PROCESSING SYSTEM, AND GAME APPARATUS

(71) Applicant: CYGAMES, INC., Tokyo (JP)

(72) Inventor: Kenta Ashizawa, Tokyo (JP)

(73) Assignee: CYGAMES, INC., Tokyo (JP)

(21) Appl. No.: 19/692,784

(22) Filed: May 29, 2026

Related U.S. Application Data
(63) Continuation of application No. PCT/JP2024/041106, filed on Nov. 20, 2024.

(30) Foreign Application Priority Data
Dec. 5, 2023 (JP) 2023-205204

(51) Int. Cl. A63F 13/46; A63F 13/69; A63F 13/80

(52) U.S. Cl. CPC A63F 13/46; A63F 13/69; A63F 13/80

(57) ABSTRACT

A non-transitory computer readable medium stores a program causing a computer to execute processing of progressing a game including a plurality of turns, processing of determining time spent by a player in a corresponding turn among the plurality of turns based on the corresponding turn ending, processing of determining first points based on a result of the game, processing of determining second points based on at least the spent time, and processing of giving a reward to a player ID based on the first points and the second points.

### CROSS REFERENCE TO RELATED APPLICATIONS

This application is a continuation application of International Application No. PCT/JP2024/041106, filed on Nov. 20, 2024, which claims priority to Japanese Patent Application No. 2023-205204, filed on Dec. 5, 2023, the entire contents of which are incorporated by reference herein.

### BACKGROUND ART

### Technical Field

The present invention relates to an information processing program, an information processing method, an information processing system, and a game apparatus.

For example, in Patent Document 1, a digital card game enabling players to play against each other through communication has been proposed. In such a digital card game, a player creates a deck, which is a group of cards selected from among a plurality of cards. The player plays the game using the deck.

### CITATION LIST

### Patent Document

Patent Document 1: JP 2018-995 A

### SUMMARY OF INVENTION

### Technical Problem

In the game in which the players play against each other as described above, there is a problem that the progress of the game is delayed when the players repeatedly take a long period of time to carefully consider play content and the like.

An object of the present invention is to provide an information processing program, an information processing method, an information processing system, and a game apparatus capable of suppressing possibility of delaying progress of a game.

### Solution to Problem

In order to solve the above problem, an information processing program causes a computer to execute processing of progressing a game including a plurality of turns, processing of determining time spent by a player in a corresponding turn among the plurality of turns based on the corresponding turn ending, processing of determining first points based on a result of the game, processing of determining second points based on at least the spent time, and processing of giving a reward to a player ID based on the first points and the second points.

The information processing program may further cause the computer to execute: processing of determining a total spent time taken until the game is ended, based on the spent time; processing of determining an operable time of the player in each of the plurality of turns; and processing of determining a total operable time that is a sum of the operable time in each of the plurality of turns executed until the game is ended, wherein the processing of determining the second points may include determining the second points based on a ratio of the total spent time to the total operable time.

The information processing program may further cause the computer to execute processing of determining an operable time of the player in each turn, wherein the processing of determining the second point may include determining the second point based on a ratio of the spent time to the operable time in each of the plurality of turns executed until the game is ended.

The plurality of turns different from each other in the operable time may be included.

The plurality of turns may include the turn of the player and the turn of an opponent, and the processing of determining the spent time includes determining the spent time of the player in the turn of the player when the turn of the player ends, and determining the spent time of the player in the turn of the opponent when the turn of the opponent ends and the player performs an operation in the turn of the opponent.

In order to solve the above problem, an information processing method is an information processing method executed by one or more computers, the method including processing of progressing a game including a plurality of turns, processing of determining time spent by a player in a corresponding turn among the plurality of turns based on the corresponding turn ending, processing of determining first points based on a result of the game, processing of determining second points based on at least the spent time, and processing of giving a reward to a player ID based on the first points and the second points.

In order to solve the above problem, an information processing system is an information processing system including one or more computers, wherein the one or more computers execute processing of progressing a game including a plurality of turns, processing of determining time spent by a player in a corresponding turn among the plurality of turns based on the corresponding turn ending, processing of determining first points based on a result of the game, processing of determining second points based on at least the spent time, and processing of giving a reward to a player ID based on the first points and the second points.

In order to solve the above problem, a game apparatus includes one or more computers, wherein the one or more computers execute processing of progressing a game including a plurality of turns, processing of determining time spent by a player in a corresponding turn among the plurality of turns based on the corresponding turn ending, processing of determining first points based on a result of the game, processing of determining second points based on at least the spent time, and processing of giving a reward to a player ID based on the first points and the second points.

### Effects of Disclosure

According to the present invention, the possibility of delaying the progress of the game can be suppressed.

### BRIEF DESCRIPTION OF DRAWINGS

FIG. 1 is an explanatory diagram illustrating a schematic configuration of an information processing system.

FIG. 2A is a diagram illustrating a hardware configuration of a player terminal. FIG. 2B is a diagram illustrating a hardware configuration of a server.

FIG. 3A is a diagram illustrating an example of a home screen. FIG. 3B is a diagram illustrating an example of a card setting screen. FIG. 3C is a diagram illustrating an example of a deck selection screen. FIG. 3D is a diagram illustrating an example of a deck edit screen in an initial state.

FIG. 4A is a diagram illustrating an example of the deck edit screen during editing. FIG. 4B is a diagram illustrating an example of a card list screen. FIG. 4C is a diagram illustrating an example of a card creation screen.

FIG. 4D is a diagram illustrating an example of a card detail screen.

FIG. 5 is a diagram illustrating an example of a battle screen.

FIG. 6A is a first diagram illustrating an example of a follower card. FIG. 6B is a first diagram illustrating an example of the follower card.

FIG. 7A is a diagram illustrating an example of a spell card. FIG. 7B is a diagram illustrating an example of an amulet card.

FIG. 8 is a diagram illustrating examples of abilities.

FIG. 9A is a first diagram illustrating an example of transition of the battle screen. FIG. 9B is a second diagram illustrating an example of the transition of the battle screen. FIG. 9C is a third diagram illustrating an example of the transition of the battle screen.

FIG. 10A is a fourth diagram illustrating an example of the transition of the battle screen. FIG. 10B is a fifth diagram illustrating an example of the transition of the battle screen. FIG. 10C is a sixth diagram illustrating an example of the transition of the battle screen.

FIG. 11A is a seventh diagram illustrating an example of the transition of the battle screen. FIG. 11B is an eighth diagram illustrating an example of the transition of the battle screen. FIG. 11C is a ninth diagram illustrating an example of the transition of the battle screen.

FIG. 12A is a tenth diagram illustrating an example of the transition of the battle screen. FIG. 12B is an eleventh diagram illustrating an example of the transition of the battle screen.

FIG. 13A is a first diagram illustrating an example of a battle screen in an evolution-unlocked turn. FIG. 13B is a second diagram illustrating an example of the battle screen in the evolution-unlocked turn.

FIG. 14A is a first diagram illustrating an example of a battle screen upon an evolution. FIG. 14B is a diagram illustrating an example of an evolution screen. FIG. 14C is a second diagram illustrating an example of the battle screen upon an evolution.

FIG. 15A is a first diagram illustrating an example of a battle screen in a super evolution-unlocked turn. FIG. 15B is a second diagram illustrating an example of the battle screen in the super evolution-unlocked turn.

FIG. 16A is a first diagram illustrating an example of a battle screen upon a super evolution. FIG. 16B is a diagram illustrating an example of a super evolution screen. FIG. 16C is a second diagram illustrating an example of the battle screen upon a super evolution.

FIG. 17 is a diagram illustrating an example of a breakdown of rank points.

FIG. 18 is a diagram illustrating an example of an operable time and a spent time.

FIG. 19A is a diagram illustrating an example of a result screen when winning. FIG. 19B is a diagram illustrating an example of a result screen when losing.

FIG. 20 is a functional block diagram of the player terminal.

FIG. 21 is a functional block diagram of the server.

FIG. 22 is a flowchart illustrating an example of terminal-side card battle game execution processing in the player terminal.

FIG. 23 is a flowchart illustrating an example of own turn control processing in the player terminal.

FIG. 24 is a flowchart illustrating an example of evolution/super evolution execution processing in the player terminal.

FIG. 25 is a flowchart illustrating an example of opponent's turn control processing in the player terminal.

FIG. 26 is a flowchart illustrating an example of server-side card battle game execution processing in the server.

FIG. 27 is a flowchart illustrating an example of ability activation processing in the server.

FIG. 28 is a flowchart illustrating an example of evolution-related processing in the server.

### DESCRIPTION OF EMBODIMENTS

Hereinafter, an aspect of an embodiment of the present invention is described in detail with reference to the accompanying drawings. Dimensions, materials, specific numerical values, and the like described in the embodiment are merely examples for facilitating understanding and do not limit the present invention unless otherwise specified. In this description and the drawings, elements having substantially the same function and configuration are denoted by the same reference numerals, and redundant description thereof is omitted, and elements not directly relating to the present invention are not illustrated.

### Overall Configuration of Information Processing System S

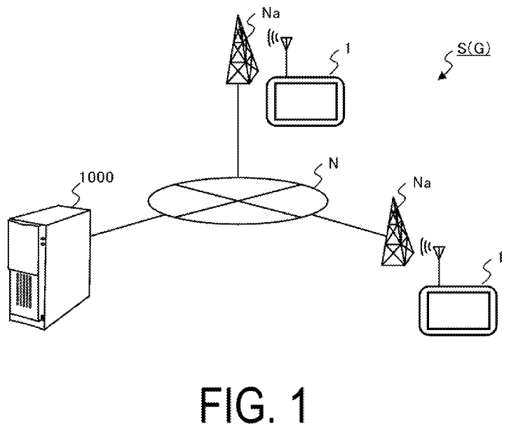

FIG. 1 is an explanatory diagram illustrating a schematic configuration of an information processing system S. The information processing system S is a so-called client-server system including a player terminal 1, a server 1000, and a communication network N including a communication base station Na.

The player terminal 1 can establish communication with the server 1000 via the communication network N. The player terminal 1 widely includes an electronic device capable of establishing a wireless or wired communication connection to the server 1000. Examples of the player terminal 1 include a smartphone, a mobile phone, a tablet device, a personal computer, or a game console. In the present embodiment, a case where a smartphone is used as the player terminal 1 is described.

The server 1000 is communicatively connected to a plurality of player terminals 1. The server 1000 accumulates various types of information (player information) for each player who plays a game. In addition, the server 1000 updates the accumulated information based on an operation input from the player terminal 1.

The communication base station Na is connected to the communication network N and wirelessly transmit and receive information to and from the player terminal 1. The communication network N is implemented as a cellular network, an Internet network, a local area network (LAN), a dedicated line, or the like, and establishes a wireless or wired communication connection between the player terminal 1 and the server 1000.

In the information processing system S of the present embodiment, the player terminal 1 and the server 1000 function as a game apparatus G. Each of the player terminal 1 and the server 1000 has a role of controlling the progress of the game, and the game can progress through cooperation between the player terminal 1 and the server 1000.

### Hardware Configurations of Player Terminal 1 and Server 1000

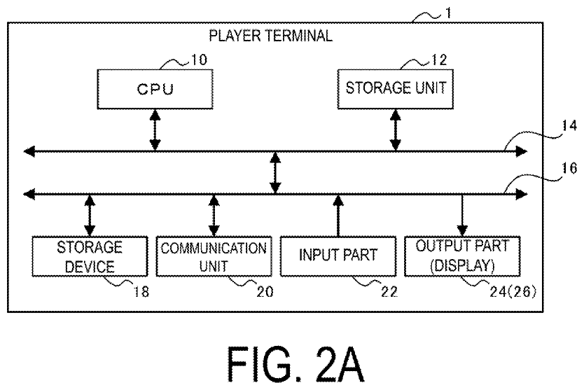

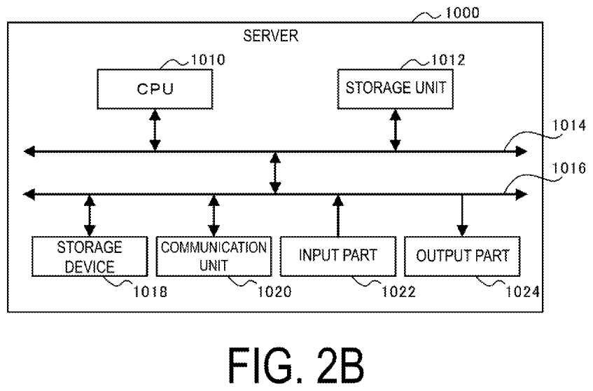

FIG. 2A is a diagram illustrating a hardware configuration of the player terminal 1. FIG. 2B is a diagram illustrating a hardware configuration of the server 1000. As illustrated in FIG. 2A, the player terminal 1 includes a central processing unit (CPU) 10, a storage unit 12, a bus 14, an input/output interface 16, a storage device 18, a communication unit 20, an input part 22, and an output part 24.

As illustrated in FIG. 2B, the server 1000 includes a CPU 1010, a storage unit 1012, a bus 1014, an input/output interface 1016, a storage device 1018, a communication unit 1020, an input part 1022, and an output part 1024.

The configurations and functions of the CPU 1010, the storage unit 1012, the bus 1014, the input/output interface 1016, the storage device 1018, the communication unit 1020, the input part 1022, and the output part 1024 of the server 1000 are substantially and respectively the same as the CPU 10, the storage unit 12, the bus 14, the input/output interface 16, the storage device 18, the communication unit 20, the input part 22, and the output part 24 of the player terminal 1. Thus, the hardware configuration of the player terminal 1 is described below, but description of the server 1000 is omitted.

The CPU 10 operates programs stored in the storage unit 12 to control the progress of the game. The storage unit 12 is implemented as a read only memory (ROM) or a random access memory (RAM) and stores programs and various types of data necessary for controlling the progress of the game. The storage unit 12 is connected to the CPU 10 via the bus 14.

The input/output interface 16 is connected to the bus 14. The storage device 18, the communication unit 20, the input part 22, and the output part 24 are connected to the input/output interface 16.

The storage device 18 is implemented as a semiconductor memory and stores various types of programs and data. In the player terminal 1, the programs and data stored in the storage device 18 are loaded into the storage unit 12 by the CPU 10.

The communication unit 20 is wirelessly and communicatively connected to the communication base station Na and transmits and receive information such as various types of data and programs to and from the server 1000 via the communication network N. In the player terminal 1, programs or the like received from the server 1000 are stored in the storage unit 12 or the storage device 18.

The input part 22 is implemented as, for example, a touch panel, a button, a keyboard, a mouse, a four-direction key, an analog controller, and the like for inputting an operation (receiving operation) of the player. Alternatively, the input part 22 may be a dedicated controller provided in the player terminal 1 or connected (externally attached) to the player terminal 1. Furthermore, the input part 22 may be implemented as an acceleration sensor that detects the inclination or movement of the player terminal 1 or a microphone that detects audio from the player. That is, the input part 22 widely includes apparatuses that allow an intention of the player to be recognizably input.

The output part 24 is implemented as a display apparatus and a speaker. Note that the output part 24 may be a device connected (externally attached) to the player terminal 1. In the present embodiment, the player terminal 1 includes a touch panel 26 that functions as the input part 22 and the output part 24.

### Details of Game

Next, details of a game provided by the information processing system S (game apparatus G) of the present embodiment are described using an example. The game of the present embodiment is a so-called digital card game. A player can acquire and possess a plurality of types of digital cards (game media, hereinafter simply referred to as cards) provided by an administrator by lottery or the like, and can play a card battle game in which the player plays against a computer or another player using the possessed cards. Hereinafter, the content of the game of the present embodiment is described in detail.

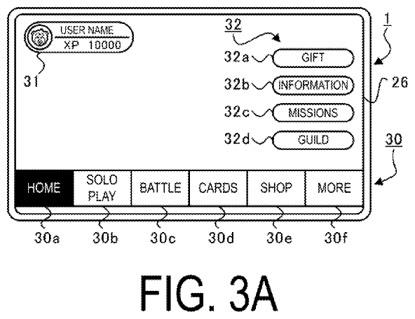

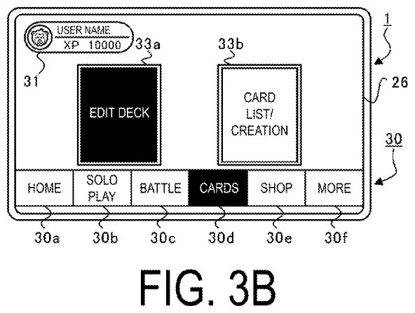

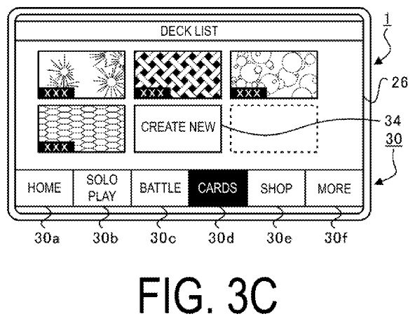

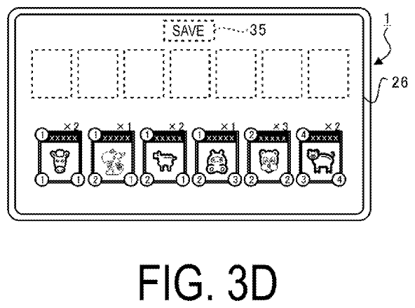

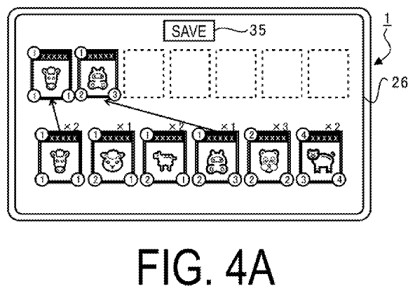

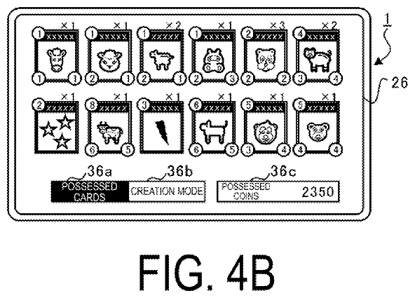

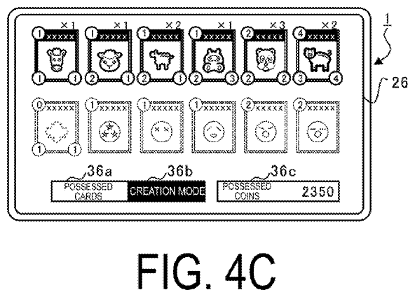

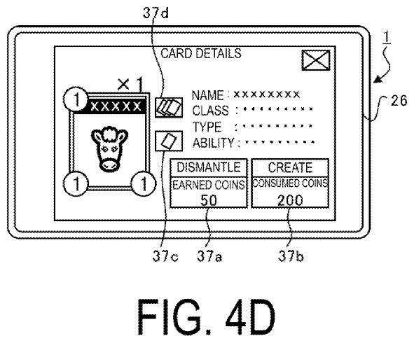

FIG. 3A is a diagram illustrating an example of a home screen. FIG. 3B is a diagram illustrating an example of a card setting screen. FIG. 3C is a diagram illustrating an example of a deck selection screen. FIG. 3D is a diagram illustrating an example of a deck edit screen in an initial state. FIG. 4A is a diagram illustrating an example of the deck edit screen during editing. FIG. 4B is a diagram illustrating an example of a card list screen. FIG. 4C is a diagram illustrating an example of a card creation screen. FIG. 4D is a diagram illustrating an example of a card detail screen.

When an application for the present game is started in the player terminal 1, the communication between the player terminal 1 and the server 1000 is started to enter a login state, and the game is started. When the game is started, various types of game screens are displayed on the touch panel 26 of the player terminal 1. In the present embodiment, the game screens are generally classified into normal screens and battle screens.

The normal screens are mainly screens on which a player makes various settings and confirms information. On the other hand, the battle screens are screens that are displayed on the touch panel 26 from the start to the end of the card battle game. Here, all the screens other than the battle screens are the normal screens. The normal screens include a plurality of screens such as a home screen illustrated in FIG. 3A, a card setting screen illustrated in FIG. 3B, a shop screen (not illustrated), and a menu screen.

The home screen illustrated in FIG. 3A is a screen that is first displayed after login. As illustrated in FIG. 3A, on the home screen, a menu bar 30 is displayed at the bottom of the touch panel 26. The menu bar 30 is provided with a plurality of operation portions that can be operated (tapped) by the player. The menu bar 30 is provided with a home screen selection operation portion 30a denoted by “Home”, a solo play selection operation portion 30b denoted by “Solo Play”, a multiplayer selection operation portion 30c denoted by “Battle”, a card setting screen selection operation portion 30d denoted by “Cards”, a shop screen selection operation portion 30e denoted by “Shop”, and a menu screen selection operation portion 30f denoted by “More”.

When the home screen selection operation portion 30a is tapped, the home screen illustrated in FIG. 3A is displayed on the touch panel 26. When the solo play selection operation portion 30b is tapped, various setting screens are displayed. When setting is performed on the setting screens, a card battle game against a computer is started. When the multiplayer selection operation portion 30c is tapped, various setting screens are displayed. When setting is performed on the setting screens, a card battle game through communication match-up against another player is started.

When the card setting screen selection operation portion 30d is tapped, the card setting screen illustrated in FIG. 3B is displayed on the touch panel 26. In the card setting screen, editing a deck, displaying a list of cards, dismantling or creating a card, and the like, which are described below, can be performed. When the shop screen selection operation portion 30e is tapped, a shop screen is displayed on the touch panel 26. In the shop screen, a card can be acquired through lottery by consuming an in-game currency or an item. When the menu screen selection operation portion 30f is tapped, a menu screen (not illustrated) is displayed on the touch panel 26. In the menu screen, game settings and various types of information can be confirmed.

A header display region 31 is provided at the upper left of the home screen illustrated in FIG. 3A. In the header display region 31, a player name, a player icon, and a rank point (XP) associated with a player ID are displayed. As is described in detail below, the rank point is given to the player ID based on execution content and an execution result of the card battle game through communication match-up against another player. However, the rank point may be given to the player ID based on the execution content or the execution result of the card battle game of a match-up against a computer. For example, a total sum of the rank points associated with the player ID may be used as an index indicating a strength of the player. Further, ranking such as bronze ranking, silver ranking, gold ranking, or the like may be performed based on the total sum of the rank points associated with the player ID. Further, ordering may be performed based on the total sum of the rank points associated with the player ID. When the rank or the order is raised, various game media, in-game currency, or the like may be given to the player ID. In addition, the various game media, the in-game currency, and the like may be given to the player ID based on the total sum of the rank points associated with the player ID. In addition, in a predetermined period such as an event period set in advance, the various game media, the in-game currency, and the like may be given to the player ID based on the total sum of the rank points associated with the player ID. The rank point may be used as, for example, the in-game currency. That is, the player may be able to purchase the various game media by using (consuming) the rank points.

A home menu 32 is displayed at the right end of the home screen. The home menu 32 is provided with a gift screen selection operation portion 32a denoted by “Gift”, an information screen selection operation portion 32b denoted by “Information”, a mission screen selection operation portion 32c denoted by “Mission”, and a guild screen selection operation portion 32d denoted by “Guild”.

When the gift screen selection operation portion 32a is tapped, for example, a gift screen (not illustrated) for displaying an item distributed from the administrator is displayed on the touch panel 26. When the information screen selection operation portion 32b is tapped, an information screen (not illustrated) for displaying update information, maintenance information, and the like is displayed on the touch panel 26. When the mission screen selection operation portion 32c is tapped, a mission screen (not illustrated) for displaying a preset mission is displayed on the touch panel 26. When the guild screen selection operation portion 32d is tapped, a guild screen (not illustrated) related to a guild (group) constituted by a plurality of players is displayed on the touch panel 26.

The card setting screen illustrated in FIG. 3B is displayed on the touch panel 26 when the card setting screen selection operation portion 30d is tapped. In the card setting screen, a deck edit tab 33a and a card list creation tab 33b are displayed. When the deck edit tab 33a is tapped, a deck selection screen illustrated in FIG. 3C is displayed. In the deck selection screen, a list of decks edited by the player is displayed. The player can edit a deck name when editing a deck. In the deck selection screen, a deck name is displayed on an icon corresponding to each deck.

In the deck selection screen, a deck creation tab 34 denoted by “Create New” is also displayed. When the player taps the deck creation tab 34, a deck edit screen illustrated in FIG. 3D is displayed on the touch panel 26 so that a new deck can be edited.

In the deck edit screen, a plurality of empty spaces are displayed in the upper row, and cards possessed by the player (hereinafter referred to as possessed cards) are displayed in the lower row. In the deck edit screen, as illustrated in FIG. 4A, by sliding a possessed card displayed in the lower row to the upper row, the slid possessed card is arranged in an empty space in the upper row. In this manner, in the deck edit screen, the possessed cards arranged in the upper row are in a temporarily registered state.

When a save tab 35 denoted by “Save” provided in the deck edit screen is tapped, deck information is stored. A deck ID is assigned to the deck information. Card group information by which all the temporarily registered possessed cards can be recognized is stored in association with the deck ID. Although not illustrated, when the save tab 35 is tapped, a screen for editing the deck name is displayed. When the editing of the deck name is completed, the card group information is stored in association with the deck ID. In addition, the deck name and the icon displayed on the deck selection screen or the like are stored in association with the deck ID.

The deck edit screen is also displayed as illustrated in FIG. 4A when any icon is tapped on the deck selection screen illustrated in FIG. 3C. However, in this case, the cards constituting the deck selected on the deck selection screen are displayed in the upper row, and the possessed cards are displayed in the lower row. In this case, a card displayed in the upper row can be changed to a possessed card displayed in the lower row by the operation of the player.

In the card battle game, a prescribed number of cards (e.g., 40 cards) are used. Thus, on the deck edit screen, deck information including card group information of the prescribed number of cards is usually stored when the prescribed number of possessed cards are temporarily registered and then the save tab 35 is tapped by the operation of the player. The deck information can be saved even when the number of temporarily registered cards is less than the prescribed number or exceeds the prescribed number, but such deck information cannot be used in the card battle game.

When the card list creation tab 33b is tapped on the card setting screen, a card list screen illustrated in FIG. 4B is displayed on the touch panel 26. The card list screen is provided with a possessed card tab 36a, a creation mode tab 36b, and a possessed coin display field 36c at the bottom of the touch panel 26. The possessed card tab 36a and the creation mode tab 36b are configured to receive a tap operation by the player. The possessed card tab 36a and the creation mode tab 36b are also displayed on a card creation screen. When the possessed card tab 36a is tapped, the card list screen illustrated in FIG. 4B is displayed, and when the creation mode tab 36b is tapped, the card creation screen illustrated in FIG. 4C is displayed. On the other hand, in the possessed coin display field 36c, the number of coins (the number of possessed coins) which are in-game currency possessed by the player is displayed.

As illustrated in FIG. 4B, the possessed cards of the player and the number of the possessed cards are displayed on the card list screen. In the card list screen, cards not possessed by the player may be displayed. In addition, as illustrated in FIG. 4C, all cards to be provided are displayed on the card creation screen regardless of whether the player possesses them. However, while cards possessed by the player are displayed in color, cards not possessed by the player are displayed in gray-out (indicated by broken lines in FIG. 4C). Thus, the player can easily recognize whether cards are in the player's possession.

When each card is tapped on the card list screen and the card creation screen, a card detail screen is displayed as illustrated in FIG. 4D. The card detail screen displays various types of information related to the tapped card, and various types of information related to the tapped card. The card detail screen is provided with a dismantle tab 37a and a creation tab 37b. The number of coins to be earned is displayed in the dismantle tab 37a. When the dismantle tab 37a is tapped, the currently selected card is resolved, and the player can acquire the number of coins to be earned displayed in the dismantle tab 37a. When a card is dismantled, the number of possessed cards decreases.

The number of coins to be consumed is displayed in the creation tab 37b. When the creation tab 37b is tapped, the selected card can be created by consuming the number of coins to be consumed displayed in the creation tab 37b. When a card is created, the number of the possessed cards increases. That is, by tapping the creation tab 37b, the player can replace the possessed coins for a card. Such a card creation function can be executed regardless of whether the player possesses a card. That is, the player can perform card creation for both cards possessed and cards not possessed.

Provided cards may include cards that can be created and cards that cannot be created, or all the provided cards may be cards that can be created. Further, a card in which a creatable time and an uncreatable time are set may be included.

In addition, as is described in detail below, there is provided a card capable of evolution during the card battle game in the cards. In the present embodiment, “evolution” means that a card selected by a player is changed to another card. When a card evolves, performance of the card is enhanced.

The card detail screen includes a first button 37c and a second button 37d. In the card detail screen of the card capable of evolution, the first button 37c is enabled. Although not illustrated, when the first button 37c is tapped, details of a post-evolution card are displayed on the card detail screen.

The card detail screen is displayed both during the card battle game and outside the card battle game. During the card battle game, the card detail screen can be displayed not only for a player's own card but also for an opponent's card. Accordingly, during the card battle game, the player can recognize to what kind of card the opponent can evolve.

Next, the card battle game is described. Hereinafter, an outline of the card battle game is described, and then the details of cards and the details of the card battle game are described in sequence. Here, the card battle game in which a player plays a match against another player is described. In the following description, another player against whom the match is played is referred to as an opponent.

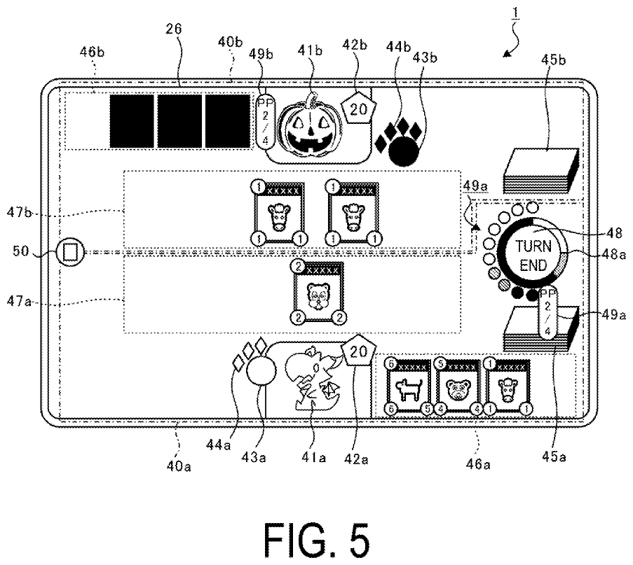

FIG. 5 is a diagram illustrating an example of the battle screen. When the multiplayer selection operation portion 30c of the menu bar 30 is tapped, various types of setting screens are displayed. Then, when setting is performed on the setting screens, a card battle game is started. During the execution of the card battle game, the battle screen illustrated in FIG. 5 is displayed on the touch panel 26.

The battle screen is divided into a player display region 40a in which cards, information, and the like of the player are displayed and an opponent display region 40b in which cards, information, and the like of the opponent are displayed. A leader 40a of the player is displayed at the lower center of the player display region 41a.

In the vicinity of the leader 41a of the player, a physical strength display region 42a indicating a physical strength of the leader 41a of the player is displayed. In addition, an evolution information display region 43a for displaying whether evolution or super evolution is available, which is described in detail later, is displayed in the vicinity of the leader 41a of the player. In addition, an evolution/super evolution point display region 44a indicating the number of remaining evolution/super evolution points associated with the player ID of the player (hereinafter, also referred to as possessed by the player), which is described in detail later, is displayed in the vicinity of the leader 41a of the player.

Similarly, a leader 40b of the opponent is displayed at the upper center of the opponent display region 41b. In the vicinity of the leader 41b of the opponent, a physical strength display region 42b indicating a physical strength of the leader 41b of the opponent is displayed. In addition, an evolution information display region 43b for displaying whether evolution or super evolution is available, which is described in detail later, is displayed in the vicinity of the leader 41b of the opponent. In addition, an evolution/super evolution point display region 44b indicating the number of remaining evolution/super evolution points possessed by the opponent, which is described in detail later, is displayed in the vicinity of the leader 41b of the player.

In the present embodiment, the physical strength of the leader 41a of the player, that is, a value displayed in the physical strength display region 42a, is set to 20 as an initial value. Similarly, the physical strength of the leader 41b of the opponent, that is, a value displayed in the physical strength display region 42b, is set to 20 as an initial value.

In the player display region 40a, a deck region 45a of the player is provided at the right end, a hand region 46a of the player is provided at the lower right, and an area 47a of the player is provided at the center. In the deck region 45a, cards of the player which are not in use are arranged in a face-down state, that is, in an unrecognizable state. In the hand region 46a, cards in the hand of the player are arranged to be recognizable to the player. In the area 47a, a card or the like brought out from the hand region 46a is arranged to be recognizable to the player.

Similarly, in the opponent display region 40b, a deck region 45b of the opponent is provided at the right end, a hand region 46b of the opponent is provided at the upper left, and an area 47b of the opponent is provided at the center. In the deck region 45b, cards of the opponent which are not in use are arranged in a face-down state. In the hand region 46b, cards in the hand of the opponent are arranged to be unrecognizable to the player, that is, in a face-down state. In the area 47b, a card or the like brought out from the hand region 46b is arranged to be recognizable to the player.

At the upper right of the player display region 40a, a turn end button 48 that receives tapping by the player, an operable time meter 48a for notification of an operable time set per turn, and a play point display portion 49a that displays a play point (PP) of the player are provided.

The operable time meter 48a is displayed around the turn end button 48. The operable time meter 48a is started to be displayed at the start of a player's turn. Then, a black part changes to cross-hatching as time elapses. That is, the black part gradually decreases as time elapses. That is, the operable time meter 48a visually suggests the remaining time of the operable time in the turn by a length and area of the black part. The operable time meter 48a is hidden when the player's turn ends.

Note that, as is described in detail below, in the present embodiment, the operable times are set which are different between before and in or after an evolution-unlocked turn in which evolution is available to the player. In the present embodiment, the length of the black part immediately after the start of displaying the operable time meter 48a changes according to the length of the operable time set for each turn. That is, the length of the black part immediately after the start of displaying the operable time meter 48a in a turn having a relatively long operable time is displayed longer than the length of the black part immediately after the start of displaying the operable time meter 48a in a turn having a relatively short operable time.

However, the length of the black part immediately after the start of displaying the operable time meter 48a may be set to a common length regardless of the length of the operable time set for each turn. In this case, a speed of decrease of the black part of the operable time meter 48a in a turn having a relatively long operable time may be set to be lower than a speed of decrease of the black part of the operable time meter 48a in a turn having a relatively short operable time.

The present embodiment describes a case that the remaining time of the operable time in each turn is visually suggested by the operable time meter 48a, but the remaining time of the operable time may be directly suggested by a numerical value. Alternatively, the remaining time of the operable time in each turn may be indirectly suggested by a change in a display mode such as a background image or an effect.

In the play point display portion 49a, the maximum play points in the current turn is displayed in the denominator, and a play point available for use is displayed in the numerator. In addition, in the play point display portion 49a, the maximum play points and the play points available for use are recognizably displayed in a circle display mode. In the vicinity of the leader 41b in the opponent display region 40b, a play point display portion 49b that displays the play points of the opponent is provided.

A battle log button 50 is provided at the left end of the battle screen. The battle log button 50 is provided to be capable of receiving a tap operation by the player. When the battle log button 50 is tapped, a battle log indicating various events that have occurred during the execution of the battle game after the tapping of the battle log button 50 is displayed to be superimposed on the battle screen.

The card battle game according to the present embodiment is a match-up game between two persons, and cards to be in the hand of a player are randomly distributed from a deck selected by the player. Similarly, cards to be in the hand of an opponent are randomly distributed from a deck selected by the opponent. In the card battle game, a player's turn and an opponent's turn are alternately repeated. In each turn, a card randomly selected from the deck is added to the hand.

In the player's turn, the player selects a follower card or an amulet card, which is described below, from the cards arranged in the hand region 46a of the player, and brings out the selected card to the area 47a, or uses a spell card to activate a predetermined effect, in accordance with a predetermined rule. Hereinafter, bringing out a follower card or an amulet card arranged in the hand region 46a or 46b to the area 47a or 47b, and using a spell card arranged in the hand region 46a or 46b to activate a predetermined effect, that is, moving a card arranged in the hand region 46a or 46b to another region, is referred to as “play”.

In the card battle game, the physical strength is set for each of the leader 41a of the player and the leader 41b of the opponent, and whichever party first wins that reduces the physical strength of the other party to 0 by an attack with a card or the like. Next, the details of the cards used in the card battle game of the present embodiment are described.

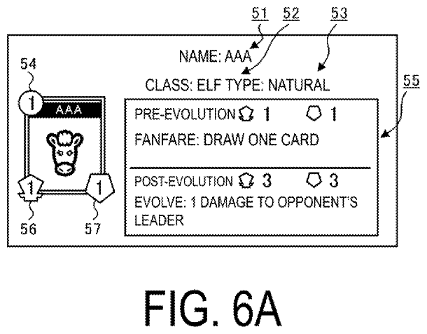

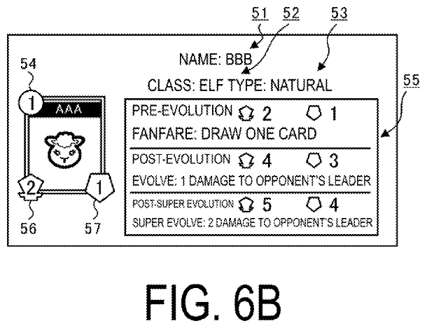

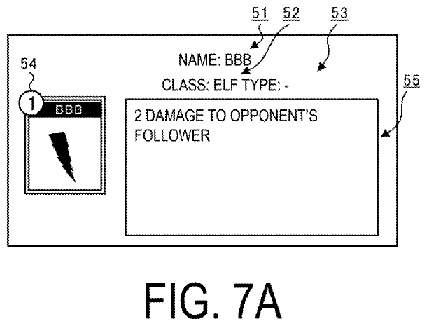

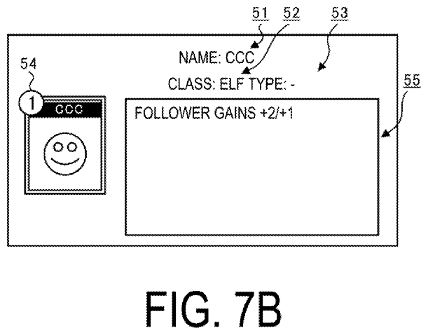

FIG. 6A is a first diagram illustrating an example of the follower card. FIG. 6B is a second diagram illustrating an example of the follower card. FIG. 7A is a diagram illustrating an example of the spell card. FIG. 7B is a diagram illustrating an example of the amulet card. Each card used in the card battle game of the present embodiment is classified into any one of card types of the follower card, the spell card, and the amulet card.

As illustrated in FIGS. 6A, 6B, 7A, and 7B, a name 51, a class 52, a type 53, and a cost 54 are set for each card regardless of the type of the card. The name 51 is uniquely set for each card. That is, the name 51 can also be referred to as a card name. The class 52 includes a plurality of classes, and each card is classified into any one of the classes. The type 53 includes a plurality of types, and each card is classified into any one of the types or is not classified into any type. The cost 54 indicates the play point necessary for playing, and a card can be played by consuming the play point corresponding to the cost.

In the card battle game, the follower cards illustrated in FIGS. 6A and 6B are cards that can attack the leader 41b of the opponent and the follower card arranged in the area 47b of the opponent. The name 51, the class 52, the type 53, the cost 54, abilities 55, an attack power 56, a physical strength 57, and an illustration are set for the follower card. The attack power 56 indicates the amount of damage given, when the follower card attacks, to the leader 41b of the opponent that is a target of the attack or a follower card arranged in the area 47b of the opponent. When the damage is given, the physical strength 57 is reduced by the amount of the damage received, and when the physical strength 57 becomes 0, the follower card is destroyed. The destroyed card is hidden from the area 47a and sent to a graveyard (not illustrated). However, a state of being hidden from the area 47b includes a state of banishing without being sent to the graveyard unlike the destruction.

In addition, in the present embodiment, the follower card can evolve by consuming the evolution point or the super evolution point displayed in the evolution/super evolution point display regions 44a and 44b. In addition, the follower card can super-evolve by consuming the super evolution point displayed in the evolution/super evolution point display region 44a or 44b. In the evolved or super-evolved follower card, the illustration is changed, the attack power 56 and the physical strength 57 are increased, or a predetermined ability 55 is added. That is, when the follower card evolves or super-evolves, the performance or effect (ability 55, attack power 56, and physical strength 57) of that card is enhanced.

In the present embodiment, the follower card capable of evolution and super evolution is set to have a higher degree of enhancement of performance and effect (ability 55, attack power 56, and physical strength 57) in the case of super evolution than in the case of evolution. That is, for the follower card capable of evolution and super evolution, the player is more advantaged in the case of super evolution than in the case of evolution. However, the follower card capable of evolution and super evolution may be set to have an equal degree of enhancement of performance and effect (ability 55, attack power 56, and physical strength 57) in a case of super evolution and in a case of evolution. However, the evolution and the super evolution may be different from each other in at least one of a mode for changing the illustration, a mode for changing the attack power 56 or the physical strength 57, and a mode for changing the ability 55.

For the spell card illustrated in FIG. 7A, the name 51, the class 52, the type 53, the cost 54, and the ability 55 are set. When a spell card is played, the ability 55 (effect) is activated and the spell card is destroyed. That is, the spell card is a card that cannot be brought out to the area 47a or 47b.

For the amulet card illustrated in FIG. 7B, the name 51, the class 52, the type 53, the cost 54, and the ability 55 are set. The amulet card is a card, when being played, staying in the area 47a to cause the ability 55 to activate.

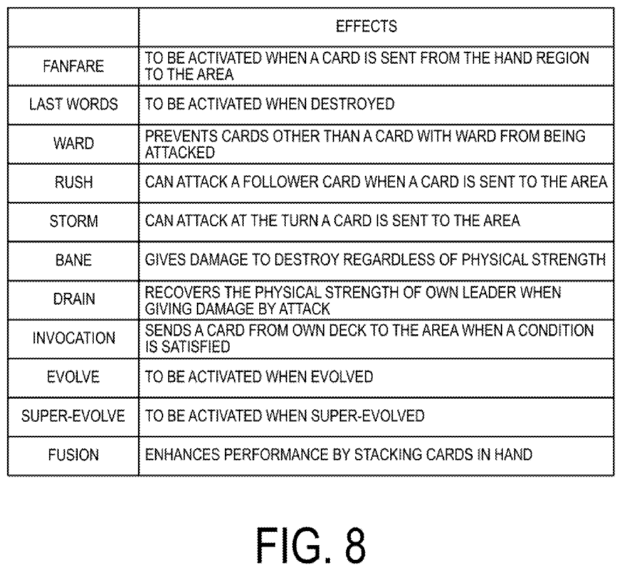

FIG. 8 is a diagram illustrating examples of the abilities 55. Note that the abilities 55 illustrated in FIG. 8 are only examples, and other abilities 55 may be provided, or some of the abilities 55 may not be necessarily provided. Here, the description is made on the assumption that cards are the player's cards, but the same description applies to the opponent's cards.

As illustrated in FIG. 8, the abilities 55 includes Fanfare, Last Words, Ward, Rush, Storm, Bane, Drain, Direct Invocation, Evolve, Fusion, and the like. The ability of Fanfare is an ability to activate the effect described in a field for “Fanfare” when a card is brought out from the hand-of-cards region 46a to the area 47a (when the card is played). For example, in the example of the follower card illustrated in FIG. 6A, when the follower card is brought out to the area 47a, the effect of “drawing one card” is activated, whereby one card is determined by lottery from the cards arranged in the deck region 45a, and the determined card is arranged in the hand region 46a.

The ability of Last Words is an ability to activate the effect described in a field for “Last Words” when the card is destroyed. The ability of Ward is an ability to prevent, when a card with Ward is arranged in the area 47a, the opponent from attacking a card other than the card with Ward. The ability of Rush is an ability to attack a follower card of the opponent in a turn in which a card with Rush is brought out to the area 47a.

The ability of Storm is an ability to attack a follower card and leader 41b of the opponent in a turn in which a card with Storm is brought out to the area 47a. The ability of Bane is an ability to destroy a follower card of the opponent regardless of the physical strength of the follower card of the opponent when a card with Bane attacks and damages the follower card of the opponent. The ability of Drain is an ability to recover the physical strength display region 42a of the leader 41a of the player by the amount of damage given to a follower card or leader 41b of the opponent in the player's turn.

The ability of Direct Invocation is an ability to directly bring out a card with Direct Invocation from the deck region 45a to the area 47a when a condition set in advance is satisfied.

Evolve is an ability to activate the effect described in a field for “Evolve” when a follower card evolves. Super Evolve is an ability to activate the effect described in a field for “Super Evolve” when a follower card super-evolves.

The ability of Fusion is an ability, which is given to a base card serving as a fusion source, to fuse a card arranged in the hand region 46a satisfying a condition set in advance as a material card to enhance the card. Note that a plurality of abilities 55 may be set in an overlapping manner, or no ability 55 may be set, for one card.

In the present embodiment, a deck is edited by combining follower cards, spell cards, and amulet cards, and a card battle game is performed using the edited deck. Hereinafter, the details of the card battle game are described.

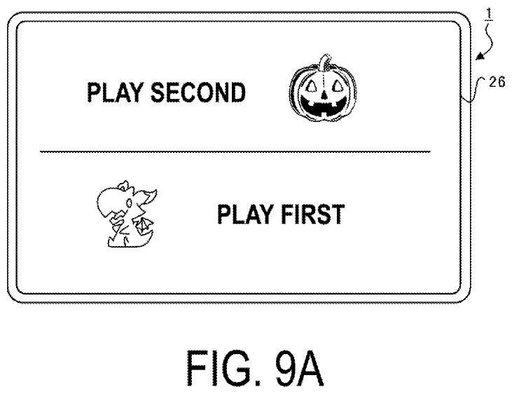

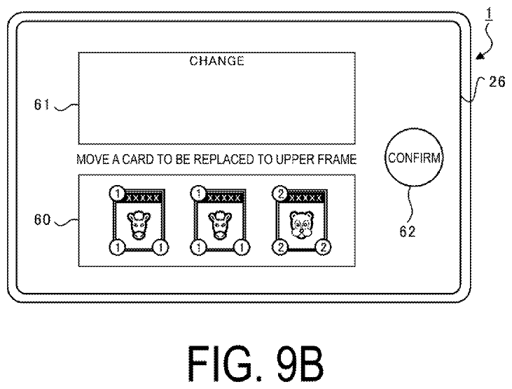

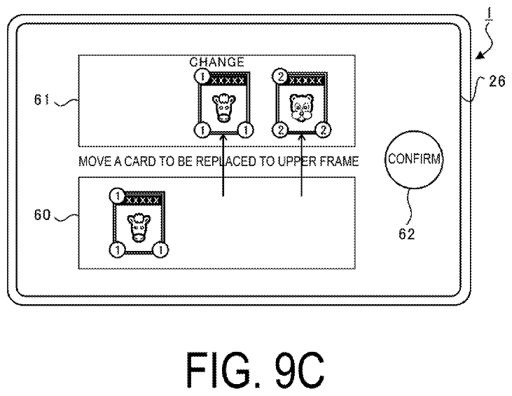

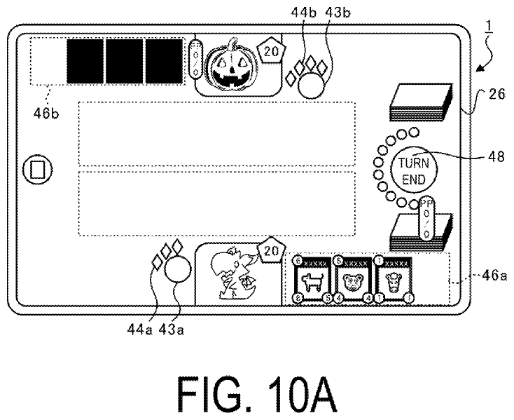

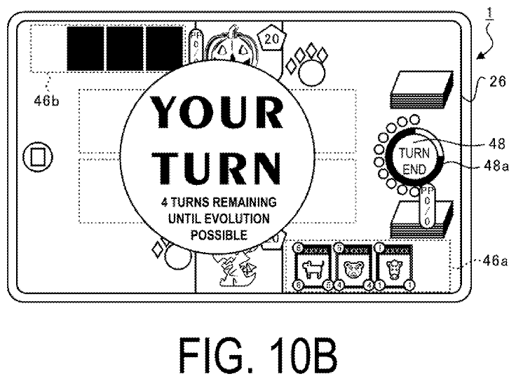

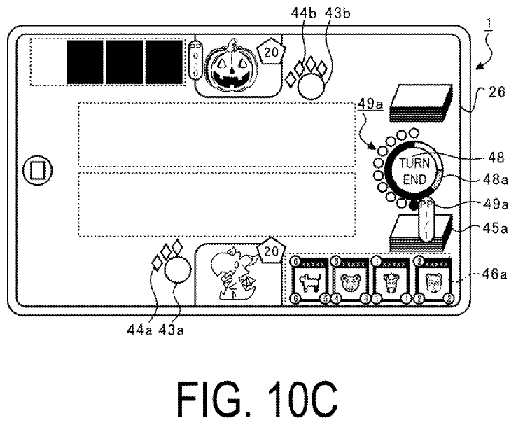

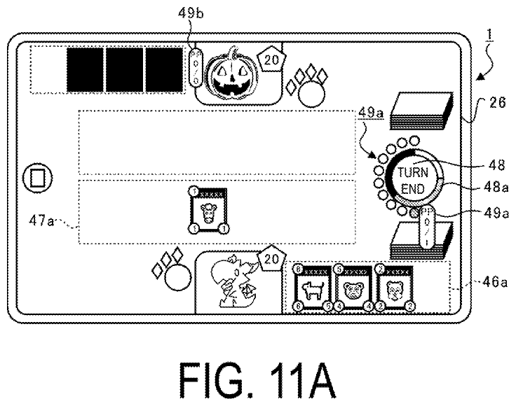

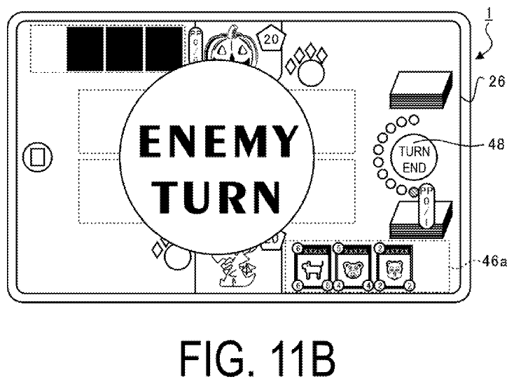

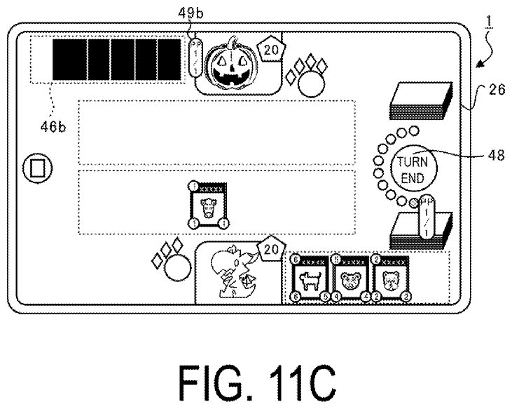

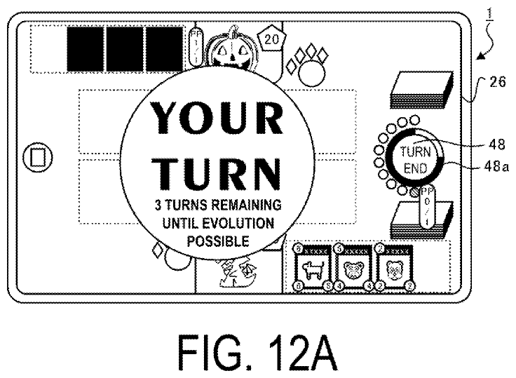

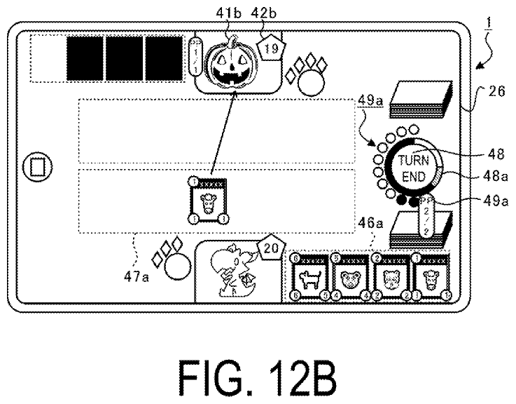

FIG. 9A is a first diagram illustrating an example of transition of the battle screen. FIG. 9B is a second diagram illustrating an example of the transition of the battle screen. FIG. 9C is a third diagram illustrating an example of the transition of the battle screen. FIG. 10A is a fourth diagram illustrating an example of the transition of the battle screen. FIG. 10B is a fifth diagram illustrating an example of the transition of the battle screen. FIG. 10C is a sixth diagram illustrating an example of the transition of the battle screen. FIG. 11A is a seventh diagram illustrating an example of the transition of the battle screen. FIG. 11B is an eighth diagram illustrating an example of the transition of the battle screen. FIG. 11C is a ninth diagram illustrating an example of the transition of the battle screen. FIG. 12A is a tenth diagram illustrating an example of the transition of the battle screen. FIG. 12B is an eleventh diagram illustrating an example of the transition of the battle screen.

When a card battle game is started, the deck information to be used is transmitted from the player terminal 1 to the server 1000. The deck information is also transmitted from the player terminal 1 of the opponent to the server 1000. The server 1000 randomly determines who plays first and who plays second. The server 1000 randomly assigns indices (e.g., numbers 1 to 40) to all cards indicated in the deck information. The server 1000 also determines three initial candidate cards and three replacement candidate cards from the cards indicated in the deck information.

Then, the server 1000 sets the initial information so as to be acquirable by the player terminal 1. The initial information includes play first or second information indicating who plays first and who plays second. The initial information also includes index information indicating an index of the card of the player. The initial information also includes replacement information indicating initial cards and replacement candidate cards. The initial information also includes evolution/super evolution turn information indicating an evolution-unlocked turn in which evolution is available to the player and a super evolution-unlocked turn in which super evolution is available to the player. The initial information also includes evolution/super evolution point information indicating the number of evolution points and the number of super evolution points given to the player ID of the player and a player ID of the opponent.

When an operation of consuming the evolution point or an operation of consuming the super evolution point is performed on the player terminal 1, the server 1000 updates the evolution/super evolution point information of the player to subtract the number of evolution points or the number of super evolution points possessed by the player. Then, the server 1000 sets the updated evolution/super evolution point information of the player so as to be acquirable by the player terminal 1 of the player and the player terminal 1 or the opponent. Similarly, when an operation of consuming the evolution point or an operation of consuming the super evolution point is performed on the player terminal 1 of the opponent, the server 1000 updates the evolution/super evolution point information of the opponent to subtract the number of evolution points or the number of super evolution points possessed by the opponent. Then, the server 1000 sets the updated evolution/super evolution point information of the opponent so as to be acquirable by the player terminal 1 of the player and the player terminal 1 of the opponent. This makes it possible for both the player terminals 1 to recognize a change in the number of evolution points or the number of super evolution points of the player or the opponent.

In the player terminal 1, when the card battle game is started, whether to play first or play second is displayed on the touch panel 26 as illustrated in FIG. 9A based on the play first or second information. Subsequently, in the player terminal 1, based on the replacement information, three initial candidate cards are arranged in an initial card display region 60, and a replacement display region 61 for arranging a card to be replaced is displayed on the touch panel 26 as illustrated in FIG. 9B.

When there is a card to be replaced among the initial candidate cards, the player moves the card to be replaced to the replacement display region 61 by a slide operation as illustrated in FIG. 9C. Then, when a determination button 62 is tapped by the player, the player terminal 1 returns the card moved to the replacement display region 61 to the deck region 45a, and determines the initial candidate cards that are not replaced as well as the replacement candidate cards the number of which corresponds to the number of replaced initial candidate cards as the initial cards. Then, the player terminal 1 transmits the initial card information indicating the determined initial cards to the server 1000.

The server 1000 also receives the initial card information from the player terminal 1 of the opponent. When receiving the initial card information from both the player and the opponent, the server 1000 sets number-of-cards information so as to be acquirable by the player terminal 1 of the player, the number-of-cards information indicating only the number of cards included in the initial card information of the opponent. Similarly, when receiving the initial card information from both the player and the opponent, the server 1000 sets number-of-cards information so as to be acquirable by the player terminal 1 of the opponent, the number-of-cards information indicating only the number of cards included in the initial card information of the player.

When receiving the number-of-cards information, the player terminal 1 displays the battle screen on the touch panel 26 as illustrated in FIG. 10A. At this time, the determined initial cards are recognizably arranged in the hand region 46a, and three cards are unrecognizably arranged in the hand region 46b based on the received number-of-cards information of the opponent. At this time, the operable time meter 48a is hidden.

Subsequently, when the player plays first, the player terminal 1 displays an image showing “YOUR TURN” that announces the player's turn on the touch panel 26 as illustrated in FIG. 10B. At this time, the player terminal 1 also displays the number of turns remaining until the evolution-unlocked turn in which evolution is available to the player. In the case illustrated in FIG. 10B, an image showing “4 turns remaining until evolution possible” is displayed on the touch panel 26.

Further, in the evolution/super evolution point display region 44a, displayed are three icon images indicating three evolution points associated with (hereinafter, also referred to as given to) the player ID of the player of a preceding play, based on the evolution/super evolution point information. At this time, since the evolution-unlocked turn of the player (the fifth turn in the present embodiment) has not been reached, three icons are displayed in the evolution/super evolution point display region 44a in a mode indicating unavailability for use (open rectangles in the figure). Further, the evolution information display region 43a is displayed in a mode indicating that evolution and super evolution are unavailable (open circle in the figure).

In addition, in the evolution/super evolution point display region 44b, displayed are four icon images indicating four evolution points given to the player ID of the opponent who plays second. At this time, since the evolution-unlocked turn of the opponent (the fourth turn in the present embodiment) has not been reached, four icons are displayed in the evolution/super evolution point display region 44a in a mode indicating unavailability for use (open rectangles in the figure). Further, the evolution information display region 43b is displayed in a mode indicating that evolution and super evolution are unavailable (open circle in the figure).

Then, in the server 1000, one of the indexes of the cards in the deck region 45a is determined by lottery. That is, here, one card in the deck region 45a is determined by lottery. Then, as illustrated in FIG. 12C, the player terminal 1 arranges the card determined by lottery in the hand-of-cards region 46a.

At the start of the turn, one is added to the play points of the player in the server 1000. The player terminal updates and displays the play point display portion 49a (here, the play points are set to one).

In addition, a turn start time and a turn end scheduled time are stored in the server 1000. The turn end scheduled time is a time obtained by adding the operable time set for the started turn to the turn start time. When the player's turn starts, the server 1000 sets the operable time set for the started turn, that is, remaining time information indicating the remaining time, to be acquirable to the player terminal 1. In addition, when the opponent's turn starts, the server 1000 sets the operable time set for the started turn, that is, the remaining time information indicating the remaining time, to be acquirable to the player terminal 1 of the opponent.

The player terminal 1 starts displaying the operable time meter 48a based on the remaining time information received from the server 1000. Note that in the present embodiment, the operable time is set to 45 seconds in the turns (the first to third turns in the present embodiment) before the evolution-unlocked turn. In the turn of or after the evolution-unlocked turn (in the present embodiment, in or after the fourth turn), the operable time is set to 70 seconds. In the turn before the evolution-unlocked turn, the length of the black part immediately after the start of displaying the operable time meter 48a is about ¾ of the circumference. As illustrated in FIGS. 10B and 10C, the black part of the operable time meter 48a gradually decreases as time elapses.

Note that, when the communication of the player terminal 1 is interrupted or the like during the player's turn, and then the communication of the player terminal 1 is restored during the player's turn, the player terminal 1 may acquire the remaining time of the operable time from the server 1000, and resume the displaying of the operable time meter 48a based on the acquired remaining time of the operable time. Note that, also when the communication of the player terminal 1 is interrupted or the like during the opponent's turn, and then the communication of the player terminal 1 is restored during the player's turn, the player terminal 1 may similarly acquire the remaining time of the operable time from the server 1000, and resume the displaying of the operable time meter 48a based on the acquired remaining time of the operable time.

Note that the present embodiment describes a case that in the turn of or after the evolution-unlocked turn, the operable time is not changed even if the player has used up all the evolution points and the super evolution points. However, the operable time may be shortened if the player has used up all the evolution points and the super evolution points.

When the player's turn or the opponent′ turn starts, the server 1000 stores the end scheduled time of the turn. When the player's turn starts, the server 1000 transmits the operable time set for the started turn, that is, the remaining time information, to the player terminal 1. When the opponent's turn starts, the server 1000 transmits the operable time set for the started turn, that is, the remaining time information indicating the remaining time, to the player terminal 1 of the opponent.

Subsequently, as illustrated in FIG. 11A, for example, when the follower card with a cost of 1 is brought out to the area 47a from among the cards arranged in the hand-of-cards region 46a by a slide operation based on the operation of the player, the server 1000 subtracts one from the play points of the player. When one is subtracted from the play points of the player in the server 1000, the player terminal 1 updates and displays the play point display portion 49a. In addition, when the ability 55 is activated by the played card, the server 1000 sets ability activation information including content of the ability 55 to activate to be acquirable to the player terminal 1 of the player and the player terminal 1 of the opponent. This allows the player terminal 1 of the player and the player terminal 1 of the opponent to recognize that the ability 55 is activated and the content of the activated ability 55.

The player terminal 1 transmits play information including the card information indicating the card brought out to the area 47a to the server 1000. When receiving the card information, the server 1000 sets the received play information so as to be acquirable by the player terminal 1 of the opponent. The server reduces the play points of the player based on the card brought out to the area 47a. Accordingly, in the player terminal 1 of the opponent, the card indicated in the card information is brought out to the area 47b of the opponent, and the play point display portion 49b of the opponent is updated and displayed.

Subsequently, when the turn end button 48 is tapped by the player, the player terminal 1 transmits turn end information indicating that the turn has ended to the server 1000. The server 1000, when receiving the turn end information, ends the player's turn. Note that when the turn end button 48 is not tapped by the turn end scheduled time, the server 1000 ends the player's turn based on the turn end scheduled time being reached.

When the card causing the ability 55 to activate on condition that the turn is ended is brought out to the area 47a or 47b, the server 1000 sets the ability activation information to be acquirable to the player terminal 1 of the player and the player terminal 1 of the opponent.

When the player's turn ends, the displaying of the operable time meter 48a ends. The server 1000 derives a spent time in the ended player's turn based on an elapsed time from the turn start time at the time point of the player's turn ending, and stores the spent time in association with the player ID. Note that when the opponent's turn ends, the server 1000 derives a spent time in the ended opponent's turn based on an elapsed time from the turn start time at the time point of the opponent's turn ending, and stores the spent time in association with the player ID of the opponent. However, the spent time may be derived for each turn after the game is ended, without deriving the spent time each time the turn ends.

That is, in the present embodiment, when the player or the opponent taps the turn end button 48, or when the turn end scheduled time is reached, a turn end condition is satisfied, and the turn ends.

When the player's turn ends, the server 1000 sets turn start information causing the opponent's turn to start, thereby causing the player terminal 1 of the opponent to start its turn.

Then, the player terminal 1 of the player displays an image showing “ENEMY TURN” that announces the opponent's turn on the touch panel 26 as illustrated in FIG. 11B. Then, in the server 1000, two cards are determined by lottery from the indexes of the cards in the deck region 45b. That is, here, two cards in the deck region 45b are determined by lottery. The player terminal 1, once acquiring the number-of-cards information from the server 1000, unrecognizably arranges the cards in the hand-of-cards region 46b based on the number-of-cards information, as illustrated in the FIG. 11C.

Note that while one card is generally determined by lottery at the start of the turn, two cards are determined by lottery only in the first turn for who plays second. Further, when one is added to the play points of the opponent in the server 1000, the player terminal 1 adds one to the play points of the opponent, and updates and displays the play point display portion 49b.

Subsequently, when the opponent ends the turn and the turn start information is received from the server 1000, the player terminal 1 displays the image showing “YOUR TURN” that announces the player's turn on the touch panel 26 as illustrated in FIG. 12A. At this time, the player terminal 1 also displays the number of turns remaining until the evolution-unlocked turn for the player. In the case illustrated in FIG. 12A, an image showing “3 turns remaining until evolution possible” is displayed on the touch panel 26.

When one of the indexes of the cards in the deck region 45a is determined by lottery in the server 1000, the player terminal 1 arranges the card determined by lottery in the hand region 46a. Further, when one is added to the play points of the player in the server 1000, the player terminal 1 updates and displays the play point display portion 49a (here, the play points are set to two).

Then, as illustrated in FIG. 12B, assume that the player slides and moves the follower card arranged in the area 47a to the leader 41b of the opponent. Based on the sliding and moving, the player terminal 1 transmits attack information indicating an attacking follower card and a follower card or leader 41b that is a target to be attacked to the server 1000. The server 1000, once receiving the attack information, sets attack result information so as to be acquirable by the player terminal 1 of the player and the player terminal 1 of the opponent, the attack result information including information indicating a result of subtraction of the physical strength of the attacked follower card or leader 41b of the opponent, information indicating a result of subtraction of the physical strength of the attacking follower card, and the like. Then, the player terminal 1 decreases the physical strength displayed in the physical strength display region 42b of the leader 41b of the opponent by the attack power 56 of the follower card of the opponent based on the received attack result information. In addition, when the ability 55 is activated by the attack, the server 1000 sets the ability activation information to be acquirable to the player terminal 1 of the player and the player terminal 1 of the opponent.

As described above, the player's turn and the opponent's turn are alternately repeated, and every time the player and the opponent play a card or make an attack, the information thereof is transmitted to the server 1000, whereby the card battle game progresses. The server 1000 derives the spent time at the end of each turn during the progress of the card battle game, and sequentially stores the derived spent time in association with the player ID of the player or the player ID of the opponent.

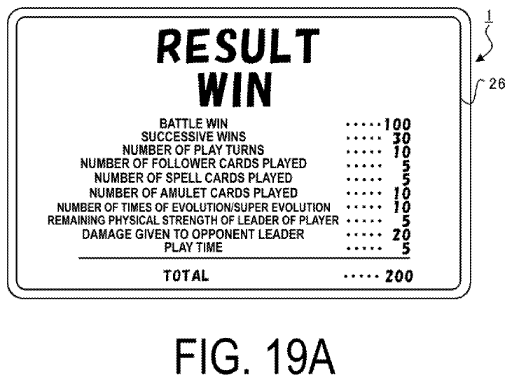

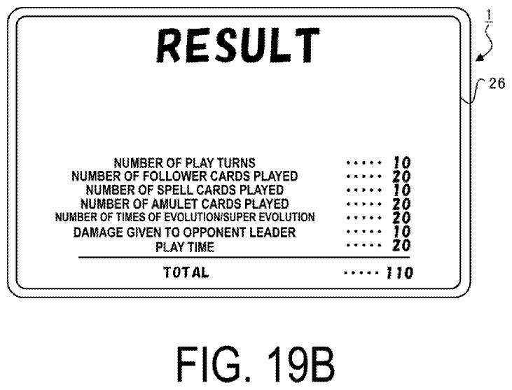

Then, when the physical strength displayed in the physical strength display region 42a of the leader 41a of the player or the physical strength displayed in the physical strength display region 42b of the leader 41b of the opponent becomes 0, winning or losing is decided, and the card battle game is ended. Note that the conditions for deciding winning or losing may include conditions other than the condition that the physical strength of the leader 41a or the leader 41b is 0. For example, winning/losing may be decided based on all the cards in the deck region 45a or the deck region 45b are used up, that is, running out in the deck. Alternatively, winning or losing may be decided based on special cards placed at the bottoms of the deck region 45a and the deck region 45b being drawn. Alternatively, winning or losing may be decided based on a special condition set in advance other than the above being satisfied. For example, the special condition may be satisfied when the ability 55 of a card in which the special ability 55 for deciding winning or losing is set is activated. When the card battle game is ended, a result screen (in FIGS. 19A and 19B) described later is displayed.

Next, the evolution of the follower card is described. In the card battle game of the present embodiment, it is possible to evolve a follower card by consuming the evolution point displayed in the evolution/super evolution point display region 44a or 44b in or after the evolution-unlocked turn. In the present embodiment, the evolution-unlocked turn is set in the fifth turn for the preceding play and the fourth turn for who plays second. However, the evolution-unlocked turn is not limited thereto. For example, the time of starting the card battle game, that is, the first turn may be the evolution-unlocked turn.

In addition, the player can super-evolve the follower card by consuming the super evolution point displayed in the evolution/super evolution point display region 44a or 44b in or after the super evolution-unlocked turn. In the present embodiment, the super evolution-unlocked turn is set in the seventh turn for the preceding play and the sixth turn for who plays second. However, the super evolution-unlocked turn is not limited thereto. In any case, the super evolution-unlocked turn may be after the evolution-unlocked turn.

Note that in the present embodiment, for the evolution point, three points are given to who plays first, and four points are given to who plays second.

In the present embodiment, when playing first, in the seventh turn, up to two evolution points are changed to two super evolution points, and the changed super evolution points are given. Specifically, when playing first, in the seventh turn, when the remaining evolution points are two or more points, two evolution points are changed to two super evolution points, and the changed super evolution points are given. When playing first, in the seventh turn, when the remaining evolution points is one point, one evolution point is changed to one super evolution point, and the changed super evolution point is given. Note that when playing first, in the seventh turn, when the remaining evolution points are zero points, the evolution points are not changed and the super evolution point is not given. For example, when the player plays the preceding play and has three evolution points in the seventh turn, two evolution points/super evolution point. As a result of this change, the player possesses one evolution point and two super evolution points.

In the present embodiment, when playing second, in the sixth turn, up to two evolution points are changed to two super evolution points, and the changed super evolution points are given. Specifically, when playing second, in the sixth turn, when the remaining evolution points are two or more points, two evolution points are changed to two super evolution points, and the changed super evolution points are given. When playing second, in the sixth turn, when the remaining evolution points are one point, one evolution point is changed to one super evolution point, and the changed super evolution point is given. Note that when playing second, in the sixth turn, when the remaining evolution points are zero points, the evolution points are not changed and the super evolution points are not given. For example, when the player plays second and has four evolution points in the sixth turn, two evolution points are changed to super evolution points. As a result of this change, the player possesses two evolution points and two super evolution points.

However, the number of points that can be changed from the evolution point to the super evolution point when a super evolution-unlocked turn number is reached is not limited to the above example. That is, at least some or all of the evolution points may be changed to the super evolution points.

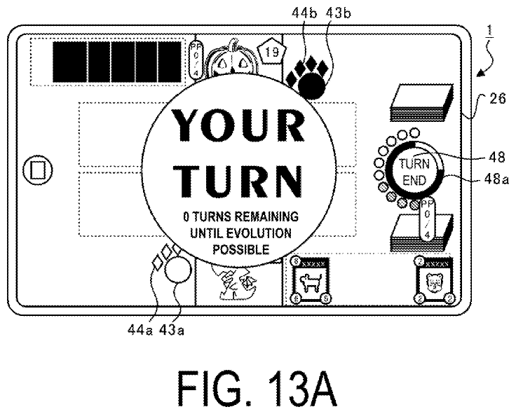

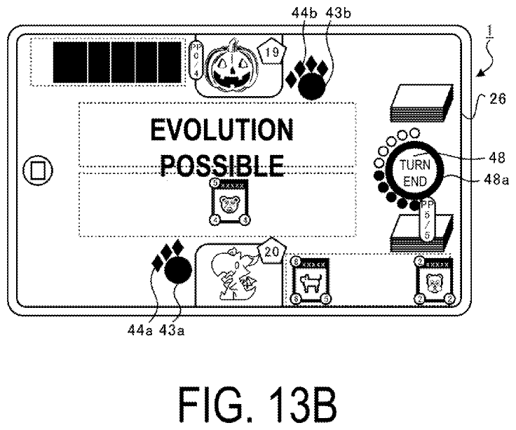

FIG. 13A is a first diagram illustrating an example of a battle screen in the evolution-unlocked turn. FIG. 13B is a second diagram illustrating an example of the battle screen in the evolution-unlocked turn. When the evolution-unlocked turn of the player (here, the fifth turn for who plays first) starts, first, an image showing “YOUR TURN” that announces the player's turn and “0 turns remaining until evolution possible” is displayed on the touch panel 26 as illustrated in FIG. 13A. Then, an image showing “Evolution Possible” is displayed at the center portion of the touch panel 26, and the player is notified that the evolution-unlocked turn has been reached as illustrated in FIG. 13B.

Further, the display mode of the icon image displayed in the evolution/super evolution point display region 44a changes to a mode indicating usability for evolution (black rectangles in the figure) as illustrated in FIG. 13B. The display mode of the evolution information display region 43a is changed to a mode indicating that evolution is possible (black circle in the figure).

At the start of the evolution-unlocked turn, first, as illustrated in FIG. 13A, the operable time meter 48a is displayed in the same mode as the turn before the evolution-unlocked turn. Thereafter, as illustrated in FIG. 13B, an animation is performed in which the black part extends over the entire circumference. This notifies the player that the operable time set for the turn has increased from that for the turn before the evolution-unlocked turn. Note that in the present embodiment, the animation of extending the black part over the entire circumference is performed only at the start of the evolution-unlocked turn, but may be performed in all turns of and after the evolution-unlocked turn. In addition, at the start of the player's turn for which the operable time longer than the operable time set for the previous player's turn is set, the animation of extending the black part over the entire circumference may be performed. In addition, at the start of the player's turn for which the operable time shorter than the operable time set for the previous player's turn is set, an animation of shortening the black part may be performed.

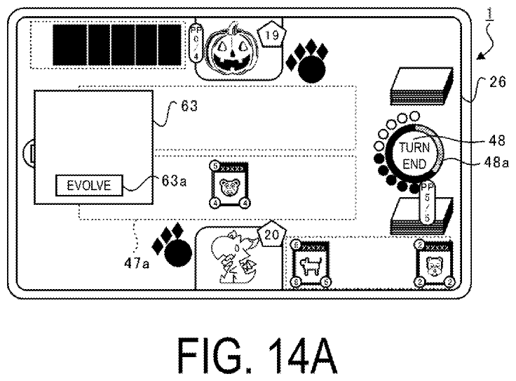

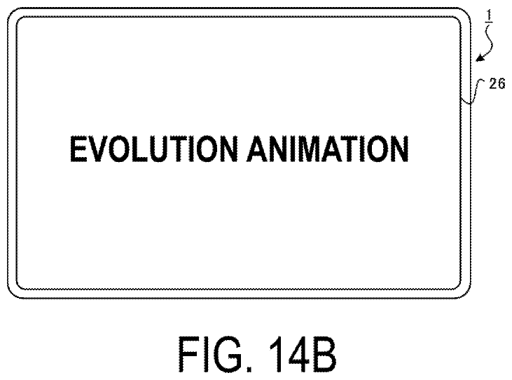

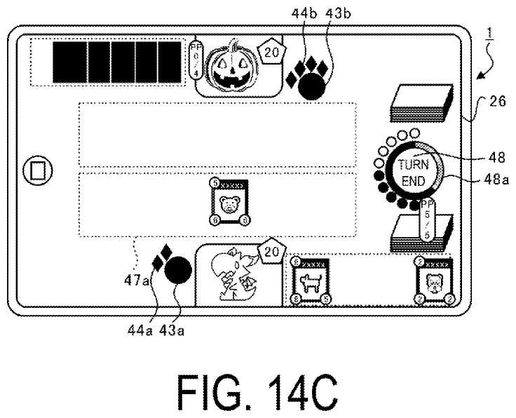

FIG. 14A is a first diagram illustrating an example of a battle screen upon an evolution. FIG. 14B is a diagram illustrating an example of an evolution screen. FIG. 14C is a second diagram illustrating an example of the battle screen upon an evolution. For example, assume that a follower card that has not evolved is arranged in the area 47a in the fifth turn for who plays first as illustrated in FIG. 14A. At this time, when the follower card arranged in the area 47a is tapped, a card detail tab 63 is displayed on the touch panel 26 as illustrated in FIG. 14A.

In the card detail tab 63, the ability of the tapped card is displayed. When the follower card tapped by the player is capable of evolution, a pre-evolution ability and a post-evolution ability are displayed in the card detail tab 63. An evolution button 63a is also displayed in the card detail tab 63.

Note that in the present embodiment, only the follower cards are set as cards capable of evolution. Therefore, the evolution button 63a is displayed only in the card detail tab 63 of the follower card, and is not displayed in the card detail tab 63 of the spell card and amulet card.

In a case capable of evolution, the evolution button 63a functions as an operation portion that receives tapping by the player. When the evolution button 63a of the card detail tab 63 is tapped, evolution of the follower card is executed. On the other hand, in a case incapable of evolution, the evolution button 63a is displayed in a mode for not receiving the tapping by the player. Note that in the case incapable of evolution, the evolution button 63a may be hidden. Specifically, the case incapable of evolution is, for example, a case that the evolution-unlocked turn has not been reached, a case that the evolution point and the super evolution point are not possessed, or a case that the follower card is incapable of evolution.

When the evolution of the follower card is executed, an evolution animation is displayed as illustrated in FIG. 14B. In the evolution animation, after a pre-evolution card is displayed, an animation image in which the card changes or the like is displayed. In the present embodiment, the evolution animation is displayed for a first time (e.g., two seconds). In the present embodiment, the decrease of the operable time meter 48a is stopped during a period from the start of the display of the evolution animation to the end of the display of the evolution animation, that is, until the first time elapses. This makes it possible to suppress the possibility that the operable time meter 48a decreases and the interest in the game is impaired in a period in which the input of various operations by the player is not received, such as during the display of the evolution animation. Note that the player terminal 1 may acquire the remaining time of the operable time at the time point of the display of the evolution animation ending from the server 1000, and resume the display of the operable time meter 48a based on the acquired remaining time of the operable time.

Then, when the display of the evolution animation ends, the post-evolution card is displayed in the area 47a as illustrated in FIG. 14C. In addition, the number of icons displayed in the evolution/super evolution point display region 44a is decreased by one. Then, the attack power 56 and the physical strength 57 of the evolved card increase. In addition, for the follower card having “Evolve” as the ability 55, the ability is activated.

Further, the player terminal 1 transmits evolution information (evolution) indicating the evolved follower card to the server 1000. The server 1000, once receiving the evolution information (evolution), sets the evolution information (evolution) so as to be acquirable by the player terminal 1 of the opponent. In the player terminal 1 of the opponent, the fact that the card has evolved and the post-evolution card can be recognized based on the received evolution information (evolution).

The player terminal 1 transmits evolution point consumption operation information indicating that an operation of consuming the evolution point has been performed to the server 1000. The server 1000 updates the evolution/super evolution point information of the player to subtract the evolution point possessed by the player based on the received evolution point consumption operation information. The server 1000 sets the updated evolution/super evolution point information of the player so as to be acquirable by the player terminal 1 of the player and the player terminal 1 of the opponent. This allows the player terminal 1 of the player and the player terminal 1 of the opponent to recognize that the evolution points of the player have decreased.

The server 1000, once receiving the evolution information (evolution), stores a time obtained by adding the first time (for example, two seconds) to the turn end scheduled time as a new turn end scheduled time. That is, the turn end scheduled time is changed in consideration of the time required for displaying the evolution animation in the player terminal 1. The changing of the turn end scheduled time in this manner makes it possible to suppress the possibility that the actual operable time of the player is reduced by displaying the evolution animation, and to suppress the possibility that the player is disadvantaged.

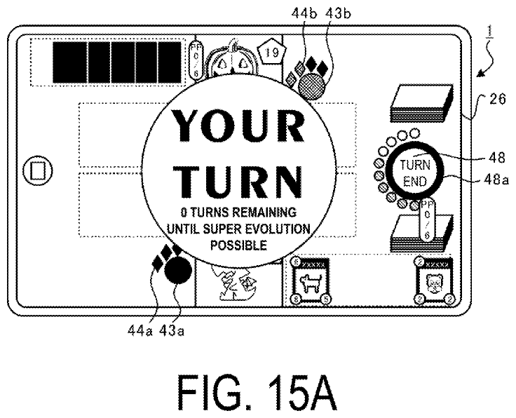

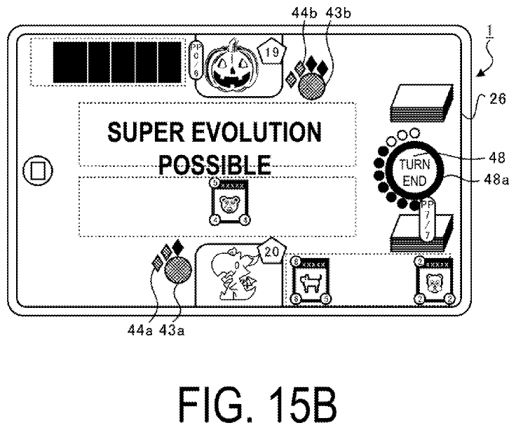

FIG. 15A is a first diagram illustrating an example of a battle screen in the super evolution-unlocked turn. FIG. 15B is a second diagram illustrating an example of the battle screen in the super evolution-unlocked turn. When the super evolution-unlocked turn of the player (here, the seventh turn for who plays first) starts, first, an image showing “YOUR TURN” that announces the player's turn and “0 turns remaining until super evolution possible” is displayed on the touch panel 26 as illustrated in FIG. 15A. Note that at the start of the player's turn after the evolution-unlocked turn, the number of turns remaining until the super evolution-unlocked turn is displayed. In the case illustrated in FIG. 15A, an image showing “0 turns remaining until super evolution possible” is displayed on the touch panel 26. Then, an image showing “Super Evolution Possible” is displayed at the center portion of the touch panel 26, and the player is notified that the super evolution-unlocked turn has been reached as illustrated in FIG. 15B. Note that at the start of the player's turn after the super evolution-unlocked turn, the image showing “YOUR TURN” that announces the player's turn is displayed, but the number of turns remaining until the evolution-unlocked turn or the super evolution-unlocked turn is not displayed.

When the super evolution-unlocked turn is reached, the evolution point is changed. FIG. 15B illustrates a case that the player possesses three evolution points. In this case, two evolution points are changed to super evolution points. As a result of this change, the player possesses one evolution point and two super evolution points. Then, in accordance with the result of the change in the evolution point, a part of the display mode of the icon image displayed in the evolution/super evolution point display region 44a (here, corresponding to two points) is changed to a mode indicating availability for use for evolution and super evolution (cross-hatching in the figure). The display mode of the evolution information display region 43a is changed to a mode indicating that evolution and super evolution are possible (cross-hatching in the figure).

In the present embodiment, the operable time set for the turn of or after the super evolution-unlocked turn is the same as the operable time set for the turn before the super evolution-unlocked turn from the evolution-unlocked turn. Therefore, at the start of the super evolution-unlocked turn, the animation of extending the black part of the operable time meter 48a over the entire circumference is not performed. However, the operable time set for the turn of or after the super evolution-unlocked turn may be longer than the operable time set for the turn before the super evolution-unlocked turn from the evolution-unlocked turn. In this case, at the start of the super evolution-unlocked turn, the animation of extending the black part of the operable time meter 48a over the entire circumference may be performed.

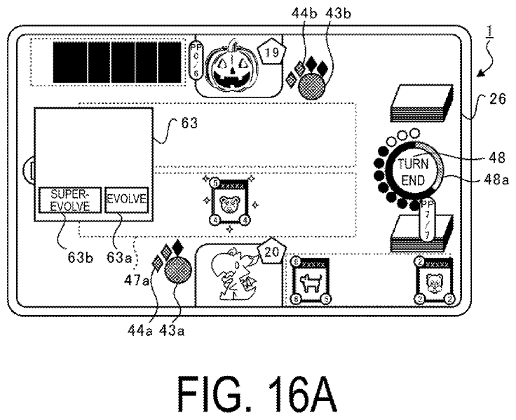

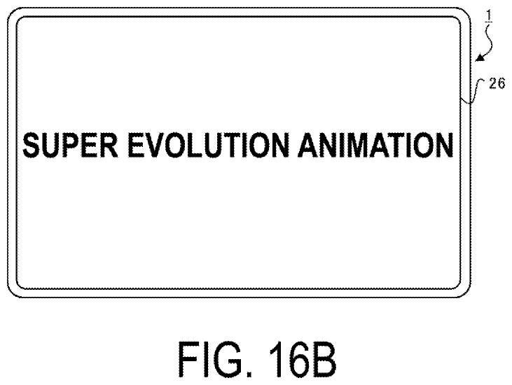

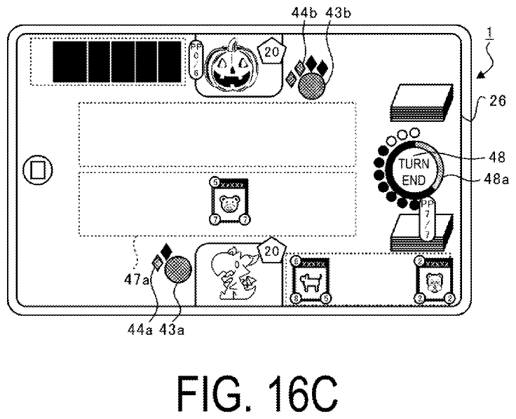

FIG. 16A is a first diagram illustrating an example of a battle screen upon a super evolution. FIG. 16B is a diagram illustrating an example of a super evolution screen. FIG. 16C is a second diagram illustrating an example of the battle screen upon a super evolution. For example, assume that a follower card that has not evolved is arranged in the area 47a in the seventh turn for who plays first as illustrated in FIG. 16A. When the follower card arranged in the area 47a is capable of super evolution, an effect image for highlighting that the follower card is capable of super evolution is displayed for the follower card as illustrated in the FIG. 16A. Then, when the follower card arranged in the area 47a is tapped, the card detail tab 63 is displayed on the touch panel 26 as illustrated in FIG. 16A.

When the follower card tapped by the player is capable of super evolution, a pre-evolution ability and a post-evolution ability are displayed in the card detail tab 63. The evolution button 63a and a super evolution button 63b are also displayed in the card detail tab 63.

Note that the super evolution button 63b is displayed only in a case that the follower card tapped by the player is capable of super evolution. That is, in a case incapable of super evolution, the super evolution button 63b is not displayed. However, in the case incapable of super evolution, the evolution button 63b may be displayed in the mode for not receiving the tapping by the player. Specifically, the case incapable of super evolution is, for example, a case that the super evolution-unlocked turn has not been reached, a case that the super evolution point is not possessed, or a case that the follower card is incapable of super evolution. When the super evolution button 63b of the card detail tab 63 is tapped, super evolution of the follower card is executed.

When the super evolution of the follower card is executed, a super evolution animation is displayed as illustrated in FIG. 16B. In the super evolution animation, after a pre-super evolution card is displayed, an animation image in which the card changes or the like is displayed. In the present embodiment, the super evolution animation is displayed for a second time (e.g., three seconds). In the present embodiment, the second time is longer than the first time (e.g., two seconds) for which the evolution animation is displayed. However, the first time and the second time may be the same length, or the first time may be longer than the second time.

In the present embodiment, the decrease of the operable time meter 48a is stopped during a period from the start of the display of the super evolution animation to the end of the display of the super evolution animation, that is, until the second time elapses. This makes it possible to suppress the possibility that the operable time meter 48a decreases and the interest in the game is impaired in a period in which the input of various operations by the player is not received, such as during the display of the super evolution animation. Note that the player terminal 1 may acquire the remaining time of the operable time at the time point of the display of the super evolution animation ending from the server 1000, and resume the display of the operable time meter 48a based on the acquired remaining time of the operable time.

Note that the super evolution animation and the evolution animation may be different from each other in at least a part of the animation images. For example, the display time of the super evolution animation may be longer and the animation image to be displayed may be showier than those of the evolution animation.

Then, when the display of the super evolution animation ends, a post-super evolution card is displayed in the area 47a as illustrated in FIG. 16B. In addition, the number of icons corresponding to the super evolution points displayed in the evolution/super evolution point display region 44a is decreased by one. Then, the attack power 56 and the physical strength 57 of the super-evolved card increase. In addition, when the follower card has “Super Evolve” as the ability 55, the ability is activated.

Further, the player terminal 1 transmits the evolution information (super evolution) indicating the super-evolved follower card to the server 1000. The server 1000, once receiving the evolution information (super evolution), sets the super evolution information (super evolution) so as to be acquirable by the player terminal 1 of the opponent. In the player terminal 1 of the opponent, the fact that the card has super-evolved and the post-super evolution card can be recognized based on the received evolution information (super evolution).

The player terminal 1 transmits super evolution point consumption operation information indicating that an operation of consuming the super evolution point has been performed to the server 1000. The server 1000 updates the evolution/super evolution point information of the player to subtract the super evolution point possessed by the player based on the received super evolution point consumption operation information. The server 1000 sets the updated evolution/super evolution point information of the player so as to be acquirable by the player terminal 1 of the player and the player terminal 1 of the opponent. This allows the player terminal 1 of the player and the player terminal 1 of the opponent to recognize that the super evolution points of the player have decreased.

The server 1000, once receiving the super evolution information (evolution), stores a time obtained by adding the second time (for example, three seconds) to the turn end scheduled time as a new turn end scheduled time. That is, the turn end scheduled time is changed in consideration of the time required for displaying the super evolution animation in the player terminal 1. The changing of the turn end scheduled time in this manner makes it possible to suppress the possibility that the actual operable time of the player is reduced by displaying the super evolution animation, and to suppress the possibility that the player is disadvantaged.

Note that the present embodiment describes a case that a timing of the end of the turn is determined based on the turn end scheduled time, but the present invention is not limited thereto. For example, an operable time timer may be set at the start of the turn for measuring the time until the end of the turn, that is, the operable time, and a value of the operable time timer may be subtracted until it becomes 0. In this case, the turn may be ended when the value of the operable time timer becomes 0. Further, when the evolution information (evolution) is received, the first time (for example, two seconds) may be added to the operable time timer. Alternatively, during the display of the evolution animation in the player terminal 1, the subtraction of the value of the operable time timer in the server 1000 may be temporarily stopped. Similarly, when the super evolution information (evolution) is received, the second time (for example, three seconds) may be added to the operable time timer. Alternatively, during the display of the super evolution animation in the player terminal 1, the subtraction of the value of the operable time timer in the server 1000 may be temporarily stopped.

As described above, when the physical strength displayed in the physical strength display region 42a of the leader 41a of the player or the physical strength displayed in the physical strength display region 42b of the leader 41b of the opponent becomes 0, winning or losing is decided, and the card battle game is ended. When the card battle game is ended, the server 1000 determines a rank point to be given to the player ID of the player and a rank point to be given to the player ID of the opponent based on the execution content and the execution result of the card battle game.

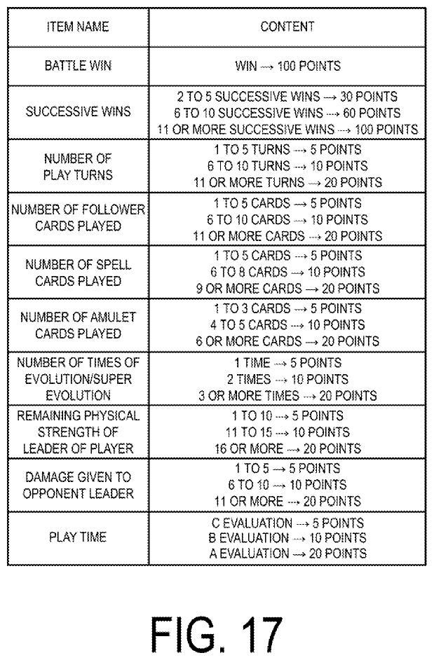

FIG. 17 is a diagram illustrating an example of a breakdown of the rank points. As illustrated in FIG. 17, in the present embodiment, a plurality of items are set for the rank points. The server 1000 determines the rank points corresponding to the respective items based on the execution content and the execution result of the card battle game, and derives a total sum of the determined rank points.

Specifically, in the item “battle win”, it is set that 100 points worth of rank points are given in a case of winning in the card battle game.

In the item “successive wins”, it is set that a rank point according to the number of times of successive wins is given in a case of successively winning in the card battle game. Specifically, it is set that 30 points worth of rank points are given in a case of successively winning two to five times. In addition, it is set that 60 points worth of rank points are given in a case of successively winning six to ten times. It is set that 100 points worth of rank points are given in a case of successively winning 11 or more times.

In the item “number of play turns”, it is set that the rank point is given according to the number of turns executed until the card battle game is ended. Specifically, it is set that five points worth of rank points are given in a case of executing one to five turns. In addition, it is set that 10 points worth of rank points are given in a case of executing six to ten turns. In addition, it is set that 20 points worth of rank points are given in a case of executing 11 or more turns.

In the item “number of follower cards played”, it is set that a rank point is given according to the number of follower cards “played” by the player until the card battle game is ended. Specifically, it is set that five points worth of rank points are given in a case of “playing” one to five follower cards. In addition, it is set that 10 points worth of rank points are given in a case of “playing” six to ten follower cards. In addition, it is set that 20 points worth of rank points are given in a case of “playing” 11 or more follower cards.

In the item “number of spell cards played”, it is set that a rank point is given according to the number of spell cards “played” by the player until the card battle game is ended. Specifically, it is set that five points worth of rank points are given in a case of “playing” one to five spell cards. In addition, it is set that 10 points worth of rank points are given in a case of “playing” six to eight spell cards. In addition, it is set that 20 points worth of rank points are given in a case of “playing” nine or more spell cards.

In the item “number of amulet cards played”, it is set that a rank point is given according to the number of amulet cards “played” by the player until the card battle game is ended. Specifically, it is set that five points worth of rank points are given in a case of “playing” one to three amulet cards. In addition, it is set that 10 points worth of rank points are given in a case of “playing” four to five amulet cards. In addition, it is set that 20 points worth of rank points are given in a case of “playing” six or more amulet cards.

In the item “number of times of evolution/super evolution”, it is set that a rank point is given according to the number of times of evolution or super evolution executed by the player until the card battle game is ended. Specifically, it is set that five points worth of rank points are given in a case of executing the evolution or super evolution one time. In addition, it is set that ten points worth of rank points are given in a case of executing the evolution or super evolution two times. In addition, it is set that 20 points worth of rank points are given in a case of executing the evolution or super evolution three or more times.

In the item “remaining physical strength of leader of player”, it is set that a rank point is given according to a value of the remaining physical strength of the leader of the player at the time point of the card battle game being ended. Specifically, it is set that five points worth of rank points are given in a case that the value of the remaining physical strength of the leader of the player is 1 to 10. In addition, it is set that ten points worth of rank points are given in a case that the value of the remaining physical strength of the leader of the player is 11 to 15. In addition, it is set that 20 points worth of rank points are given in a case that the value of the remaining physical strength of the leader of the player is 16 or more.

In the item “damage given to opponent leader”, it is set that a rank point is given according to a value of the damage given to the opponent leader until the card battle game is ended. Specifically, it is set that five points worth of rank points are given in a case that the value of the damage given to the opponent leader is 1 to 5. In addition, it is set that ten points worth of rank points are given in a case that the value of the damage given to the opponent leader is 6 to 10. In addition, it is set that 20 points worth of rank points are given in a case that the value of the damage given to the opponent leader is 11 or more.

In the item “play time”, it is set that a rank point is given based on a result of an evaluation which is performed based on the spent time at the end of each turn in the card battle game with three stages of A evaluation, B evaluation, and C evaluation. Specifically, it is set that 20 points worth of rank points are given in a case of the A evaluation. In addition, it is set that ten points worth of rank points are given in a case of the B evaluation. In addition, it is set that five points worth of rank points are given in a case of the C evaluation. An example of the evaluation method is listed below.

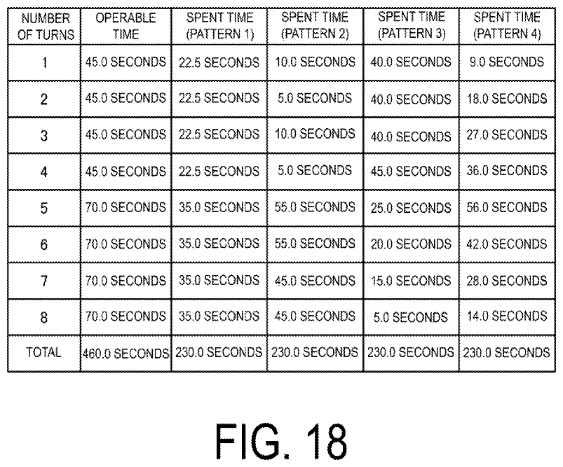

FIG. 18 is a diagram illustrating an example of the operable time and the spent time. The server 1000 derives a total spent time by summing up all the derived spent times of the respective turns. Note that when the evolution is executed during the turn, the server 1000 derives, as the spent time, a time obtained by subtracting the first time from the elapsed time from the turn start time at the time point of the turn ending. When the super evolution is executed during the turn, the server 1000 derives, as the spent time, a time obtained by subtracting the second time from the elapsed time from the turn start time at the time point of the turn ending. The server 1000 derives a total operable time obtained by summing up all the operable times of the respective turns executed in the card battle game.

In the present embodiment, the server 1000 derives a ratio of the total spent time to the total operable time (hereinafter, also referred to as a spent time ratio). Then, the evaluation is performed based on the spent time ratio. Specifically, when the spent time ratio is 50% or less, the evaluation A is determined. When the spent time ratio is 51% or more and 60% or less, the evaluation B is determined. When the spent time ratio is 61% or more, the evaluation C is determined. That is, the lower the spent time ratio, the higher the evaluation.

FIG. 18 illustrates four patterns having the same total spent time. Pattern 1 illustrates a case that 50% of the operable time is spent in all the turns. Pattern 2 illustrates a case that the turn is ended relatively early in the turn before the evolution-unlocked turn, and the turn is ended relatively late in the turn of or after the evolution-unlocked turn. Pattern 3 illustrates a case that the turn is ended relatively late in the turn before the evolution-unlocked turn, and the turn is ended relatively early in the turn of or after the evolution-unlocked turn. Pattern 4 illustrates a case that the turn is ended at a time varying for each turn.

In the present embodiment, in the case of the above-described patterns 1 to 4, although the spent times in the respective turns may be different from each other, the spent time ratio is the same value, and as a result, the same evaluation (for example, A evaluation) is obtained in all cases. That is, regardless of the time allocation in each turn, the same evaluation result is derived if the total spent time is the same. Note that the present embodiment describes the case that the spent time in each turn is derived, but the spent time may not be derived.

For example, a rank point may be given according to a ratio of a value obtained by summing up all values of the remaining times of the operable times at the time points of the respective turns ending to the total operable time.

Further, the ratio of the spent time to the operable time in each turn may be derived. In this case, all the ratios of the spent times to the operable times in the respective turns may be averaged, and the rank point according to the averaged value may be given. In this case, in patterns 1 and 4, the ratio is derived as 50%. In pattern 2, the ratio is derived as 44%. In pattern 3, the ratio is derived as 57%. That is, in this case, when the spent time is the same between the case that the operable time is long and the case that the operable time is short, the ratio of the spent time to the operable time is derived to be lower in the latter case. In other words, it can be said that the value contributing to the evaluation is higher in one second in the turn before the evolution-unlocked turn than in one second in the turn of or after the evolution-unlocked turn. This makes it possible to perform evaluation based on the length of the operable time in each turn.

Further, a ratio of a value of each remaining time of each operable time at the time point of each turn ending to the total operable time may be derived. In this case, all the ratios of the values of the remaining times of the operable times at the time points of the respective turns ending to the operable times in the respective turns may be averaged, and the rank point according to the averaged value may be given. That is, the rank point may be determined based on a ratio of the remaining times of the respective turns to the total operable time.

In addition, an evaluation score may be derived based on the value of the spent time in each turn. In this case, a rank point may be given according to a total evaluation score obtained by summing up all the evaluation scores in the respective turns. In this case, it is preferable to set a criterion for determining the evaluation score in advance for each turn. For example, in a turn before the evolution-unlocked turn, a criterion may be provided such as the evaluation score of three points when the spent time is 23 seconds or less, the evaluation score of two points when the spent time is 24 to 30 seconds, and the evaluation score of one point when the spent time is 31 seconds or more. In the turn of or after the evolution-unlocked turn, a criterion may be provided such as the evaluation score of three points when the spent time is 35 seconds or less, the evaluation score of two points when the spent time is 36 to 45 seconds, and the evaluation score of one point when the spent time is 46 seconds or more. Further, the criterion for determining the evaluation score may be different for each of the plurality of turns having the same operable time.

Further, an average value of the values of the spent times in the respective turns may be derived. In this case, a rank point may be given corresponding to the average value of the values of the spent times in the respective turns. In addition, a rank point may be given based on the number of spent times shorter than a preset reference time for the spent time in each turn. In addition, a rank point may be given to the player or the opponent, whichever has a larger number of turns with a shorter spent time on the basis of comparing the spent times of the player and the opponent in each turn.

An average value of the remaining times of the operable times at the time point of the respective turns ending may be derived. In this case, a rank point may be given according to the average value of the remaining times of the operable times at the time point of the respective turns ending.

Although the present embodiment describes the case that the player cannot perform an operation such as playing a card during the opponent's turn, the player may be able to perform an operation such as playing a card when a predetermined condition is satisfied during the opponent's turn. In this case, the operable time of the player during the opponent's turn is set. In this case, when the opponent's turn ends and the player performs an operation such as playing a card, the spent time of the player during the opponent's turn is stored. Note that, even if an operation such as playing a card can be performed when a predetermined condition is satisfied during the opponent's turn, the spent time of the player during the opponent's turn may not be stored when the player does not perform an operation. Then, the evaluation as described above may be performed based on the operable time and the spent time of the player during the opponent's turn and the operable time and the spent time of the player during the player's turn.

In any case, the server 1000 may determine the rank point based on at least the spent time for each of the player and the opponent.

The server 1000 determines the rank points corresponding to the respective items for each of the player and the opponent as described above. Further, when the server 1000 derives the total sum of the determined rank points, the server 1000 gives the total sum of the determined rank points to each of the player ID of the player and the player ID of the opponent.

However, a value may be derived by adding top three types of rank points having a larger number of points among the rank points corresponding to the items excluding the “battle win” among the items set in FIG. 17 to a basic point (for the item “battle win”).

Then, the server 1000 sets corresponding rank point information to be acquirable to the player terminal 1 of the player and the player terminal 1 of the opponent.

FIG. 19A is a diagram illustrating an example of the result screen when winning. FIG. 19B is a diagram illustrating an example of the result screen when losing. Each of the player terminal 1 of the player and the player terminal 1 of the opponent displays the result screen based on the received rank point information. The result screen displays a total sum of the rank points to be given and a breakdown of the rank points to be given. However, the breakdown of the rank points may not be displayed, or only some of the rank points may be displayed. Further, the breakdown of the rank points may be displayed to be scrollable. Note that the items to which no rank point is given may not be displayed on the result screen.

In the present embodiment, when the card battle game is won, an image showing “WIN” that announces the winning is displayed as a winning/losing result, as illustrated in FIG. 19A. On the other hand, when the card battle game is lost, the winning/losing result as losing is not directly displayed as illustrated in FIG. 19B. This makes it possible to suppress the possibility of decreasing the motivation of the player to play the game.

When the result screen is tapped, the display of the result screen ends, and the display is switched from the battle screen to the normal screen. That is, the result screen is a part of the battle screen. Note that the normal screen switched from the result screen may be a screen displayed immediately before switching to the battle screen, or may be a predetermined screen such as a home screen.

As described above, in the present embodiment, in the item “play time”, the smaller the time consumption of the player in each turn, the larger the rank point to be given, regardless of winning/losing. Therefore, the player tries to perform a quick operation in order to acquire a large number of rank points. This makes it possible to suppress the possibility of delaying progress of a game and the possibility of decreasing the interest in the game.

Hereinafter, processing of the player terminal 1 and the server 1000 for realizing the above-described card battle game, and functional units for executing the processing are described.

### Functional Units of Player Terminal 1

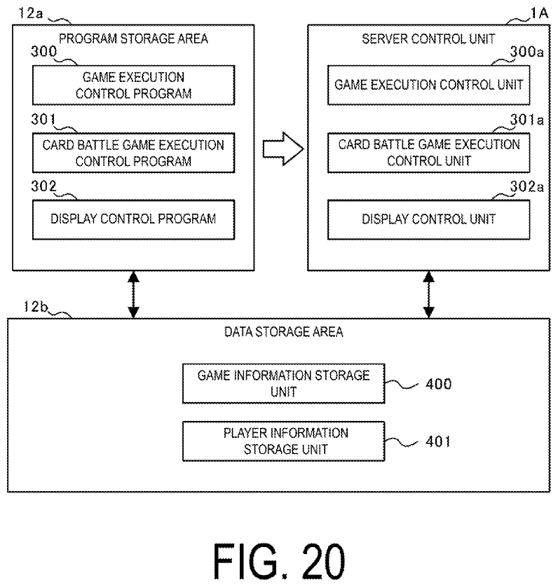

FIG. 20 is a functional block diagram of the player terminal 1. The storage unit 12 of the player terminal 1 is provided with a program storage area 12a and a data storage area 12b. At the start of the game, the CPU 10 stores a terminal-side game control program (module) in the program storage area 12a.

The terminal-side game control program includes a game execution control program 300, a card battle game execution control program 301, and a display control program 302. Note that the programs listed in FIG. 20 are examples, and many other programs are provided in the terminal-side game control program.

The CPU 10 operates each program stored in the program storage area 12a and updates the data in each storage unit of the data storage area 12b. Then, the CPU 10 causes the player terminal 1 (computer) to function as a terminal control unit 1A by running each program stored in the program storage area 12a. The terminal control unit 1A includes a game execution control unit 300a, a card battle game execution control unit 301a, and a display control unit 302a.

Specifically, the CPU 10 runs the game execution control program 300 to cause the computer to function as the game execution control unit 300a. Similarly, the CPU 10 runs the card battle game execution control program 301 and the display control program 302 to cause them to function as the card battle game execution control unit 301a and the display control unit 302a, respectively.

The data storage area 12b is provided with a game information storage unit 400 and a player information storage unit 401 as storage units for storing data. Note that the above-described storage units are merely examples, and many other storage units may be provided in the data storage area 12b.

The game execution control unit 300a controls the progress of the entire game. The game execution control unit 300a, for example, logs in to the game in response to an operation of the player, and determines whether the game information of the entire game has been updated.

The card battle game execution control unit 301a is responsible for control to execute the card battle game. For example, the card battle game execution control unit 301a controls the progress of the card battle game based on an operation input to the player terminal 1.

The display control unit 302a performs a display control for an image displayed on the touch panel 26 in accordance with an operation by the player and the progress of the game.

### Functional Units of Server 1000

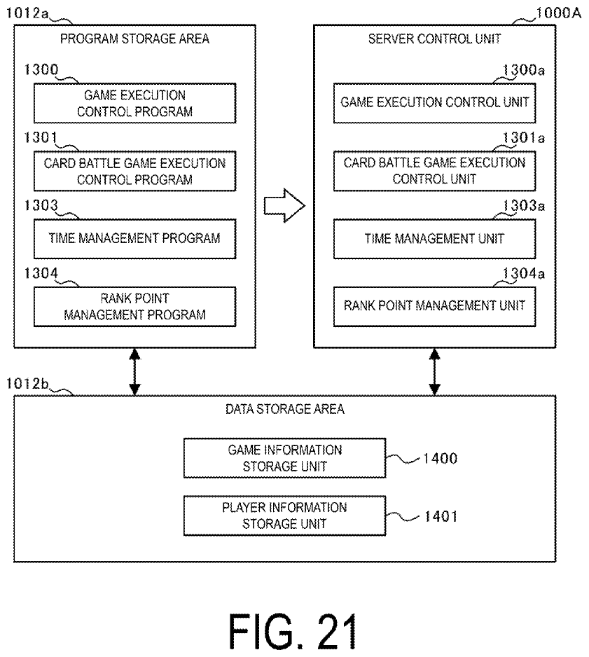

FIG. 21 is a functional block diagram of the server 1000. The storage unit 1012 of the server 1000 is provided with a program storage area 1012a and a data storage area 1012b. The program storage area 1012a stores a game execution control program 1300, a card battle game execution control program 1301, a time management program 1303, and a rank point management program 1304 as server-side game control programs. Note that the programs listed in FIG. 21 are examples, and many other programs are provided in the server-side game control program.

The CPU 1010 operates each program stored in the program storage area 1012a and updates the data in each storage unit of the data storage area 1012b. Then, the CPU 1010 causes the server 1000 (computer) to function as a server control unit 1000A by running each program stored in the program storage area 1012a. The server control unit 1000A includes a game execution control unit 1300a, a card battle game execution control unit 1301a, a time management unit 1303a, and a rank point management unit 1304a.

Specifically, the CPU 1010 runs the game execution control program 1300 to cause the computer to function as the game execution control unit 1300a. Similarly, the CPU 1010 runs the card battle game execution control program 1301, the time management program 1303, and the rank point management program 1304 to cause them to function as the card battle game execution control unit 1301a, the time management unit 1303a, and the rank point management unit 1304a, respectively.

The data storage area 1012b is provided with a game information storage unit 1400 and a player information storage unit 1401 as storage units for storing data. Note that the above-described storage units are merely examples, and many other storage units may be provided in the data storage area 1012b.

The game execution control unit 1300a controls the progress of the entire game. For example, upon receiving login information from the player terminal 1, the game execution control unit 1300a sets the player information stored in the player information storage unit 1401 (such as the deck information and the rank point) to be acquirable to the player terminal 1. When the game information of the entire game (including card information, attack information, attack result information, play point information, play information, ability activation information, turn start information, turn end information, evolution/super evolution point information, evolution information (evolution), evolution information (super evolution), winning/losing information, remaining time information, rank point information, and the like) is updated, the game execution control unit 1300a reads the updated game information from the game information storage unit 1400 and sets the read information to be acquirable to the player terminal 1.

The card battle game execution control unit 1301a is responsible for control to execute the card battle game.

The time management unit 1303a manages the operable time in each turn of the card battle game and the spent time at the end of the turn. For example, when the player's turn starts, the time management unit 1303a stores the turn start time and the turn end scheduled time in association with the player ID. When the opponent's turn starts, the time management unit 1303a stores the turn start time and the turn end scheduled time in association with the player ID of the opponent. The turn end scheduled time is a time obtained by adding the operable time set for the started turn to the turn start time.

The time management unit 1303a derives a spent time in the ended player's turn based on an elapsed time from the turn start time at the time point of the player's turn ending, and stores the spent time in association with the player ID. When the opponent's turn ends, the time management unit 1303a derives a spent time in the ended opponent's turn based on an elapsed time from the turn start time at the time point of the opponent's turn ending, and stores the spent time in association with the player ID of the opponent. However, the spent time may be derived for each turn after the game is ended, without deriving the spent time each time the turn ends.

Note that when the evolution is executed during the turn, the time management unit 1303a derives, as the spent time, a time obtained by subtracting the first time from the elapsed time from the turn start time at the time point of the turn ending. When the super evolution is executed during the turn, the time management unit 1303a derives, as the spent time, a time obtained by subtracting the second time from the elapsed time from the turn start time at the time point of the turn ending.

The time management unit 1303a derives a total operable time obtained by summing up all the operable times of the player's turns executed in the card battle game and stores the total operable time in association with the player ID. Further, the time management unit 1303a derives a total operable time obtained by summing up all the operable times of the opponent's turns executed in the card battle game and stores the total operable time in association with the player ID of the opponent.

The rank point management unit 1304a determines a rank point to be given to the player ID of the player and a rank point to be given to the player ID of the opponent based on the execution content and the execution result of the card battle game.

### Communication Processing Between Player Terminal 1 and Server 1000

Hereinafter, basic processing of the player terminal 1 and the server 1000 is described. Note that in the following description, the processing performed in the player terminal 1 is denoted by Pn (n is any integer). Processing performed in the server 1000 is denoted by Sn (n is any integer).

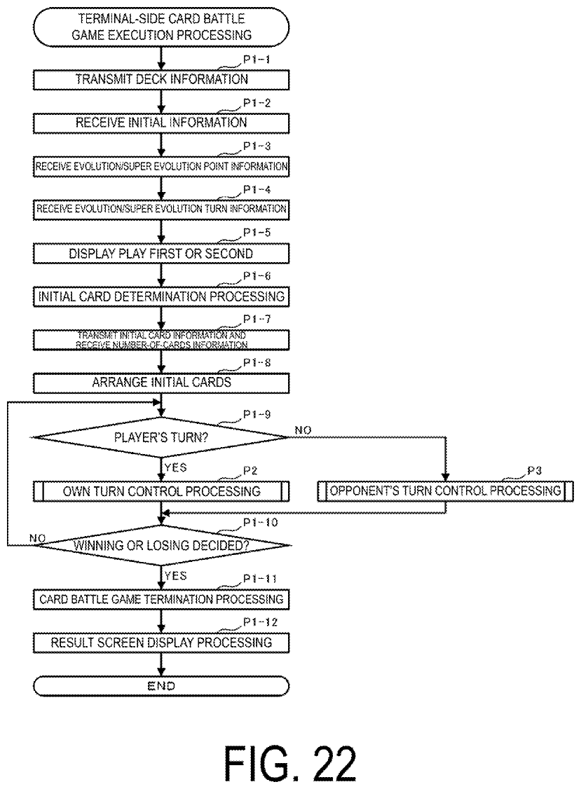

FIG. 22 is a flowchart illustrating an example of terminal-side card battle game execution processing in the player terminal 1. When the solo play selection operation portion 30b or multiplayer selection operation portion 30c of the menu bar 30 is tapped, various types of setting screens are displayed. Then, when setting is performed on the setting screens, the terminal-side card battle game execution processing is initiated.

When the card battle game execution processing is initiated, the card battle game execution control unit 301a transmits the deck information used in the card battle game to the server 1000 (P1-1).

The card battle game execution control unit 301a acquires the initial information (play first or second information, index information, and replacement information) from the server 1000 (P1-2).

The card battle game execution control unit 301a receives and stores the evolution/super evolution point information included in the initial information from the server 1000 (P1-3). At this time, when the player plays first, three evolution points are stored. When the player plays second, four evolution points are stored.

The card battle game execution control unit 301a receives and stores the evolution/super evolution turn information included in the initial information from the server 1000 (P1-4). At this time, when the player plays first, the fifth turn is stored as an evolution-unlocked turn number. In addition, when the player plays first, the seventh turn is stored as a super evolution-unlocked turn number. When the player plays second, the fourth turn is stored as the evolution-unlocked turn number. When the player plays second, the sixth turn is stored as the evolution-unlocked turn number. Note that the evolution/super evolution turn information may not be stored in the player terminal 1.

The display control unit 302a displays whether to play first or play second on the touch panel 26 based on the play first or second information included in the initial information received from the server 1000 as illustrated in FIG. 9A (P1-5). Subsequently, the card battle game execution control unit 301a executes initial card determination processing of determining the initial cards based on the replacement information included in the initial information (P1-6). Here, as illustrated in FIG. 9B, the display control unit 302a arranges three initial candidate cards in the initial card display region 60 and displays the replacement display region 61 for arranging cards to be replaced on the touch panel 26 based on the initial information (play first or second information).

Then, when the determination button 62 is tapped by the player as illustrated in FIG. 9C, the card battle game execution control unit 301a returns the cards having moved to the replacement display region 61 to the deck region 45a and determines the initial candidate card that is not replaced as well as the replacement candidate cards the number of which corresponds to the number of replaced initial candidate cards as the initial cards. Then, the card battle game execution control unit 301a transmits the initial card information indicating the initial cards to the server 1000, and receives the number-of-cards information of the opponent (P1-7).

The display control unit 302a displays the battle screen on the touch panel 26 as illustrated in FIG. 10A, and recognizably arranges the determined initial cards in the hand region 46a. In addition, the display control unit 302a unrecognizably arranges three cards in the hand region 46b based on the received number-of-cards information of the opponent (P1-8).

Subsequently, the card battle game execution control unit 301a determines whether it is the player's turn based on the play first or second information or the turn start information acquired from the server 1000 (P1-9). Then, when it is the player's turn (YES in P1-9), the card battle game execution control unit 301a executes own turn control processing (P2). On the other hand, when it is not the player's turn, that is, when it is the opponent's turn (NO in P1-9), the card battle game execution control unit 301a executes opponent's turn control processing (P3).

Then, when the card battle game execution control unit 301a does not receive the winning/losing information from the server 1000, that is, when winning or losing is not decided (NO in P1-10), the card battle game execution control unit 301a returns the processing to P1-9. When the card battle game execution control unit 301a receives the winning/losing information from the server 1000, that is, winning or losing is decided (YES in P1-10), the card battle game execution control unit 301a performs card battle game end processing of ending the card battle game (P1-11).

The display control unit 302a acquires the rank point information from the server 1000, displays the result screen (in FIG. 19A or 19B) on the touch panel 26 based on the acquired rank point information (P1-12), and terminates the card battle game execution processing.

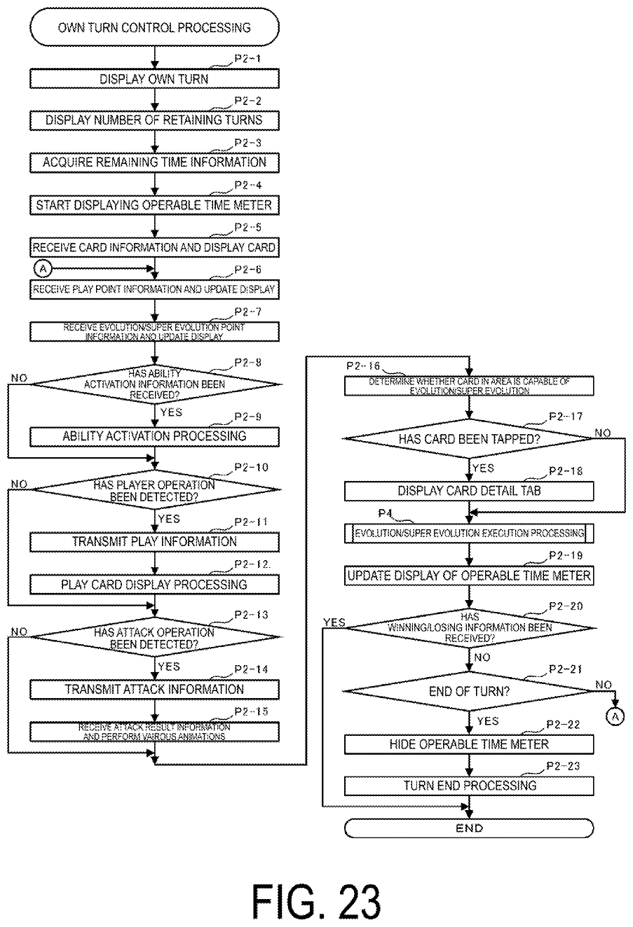

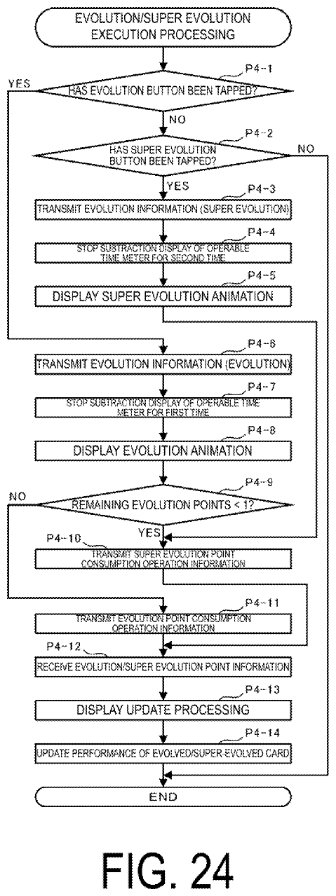

FIG. 23 is a flowchart illustrating an example of the own turn control processing (P2) in the player terminal 1. When the player's turn starts, the display control unit 302a displays an image showing “YOUR TURN” that announces the player's turn (P2-1) on the touch panel 26 as illustrated in FIG. 10B. The display control unit 302a displays the number of turns remaining until the evolution-unlocked turn in which the player is capable of evolution (FIG. 10B) or the number of turns remaining until the super evolution-unlocked turn in which the player is capable of super evolution (FIG. 15A) (P2-2).

The display control unit 302a acquires the remaining time information from the server 1000 and stores the remaining time information (P2-3). The display control unit 302a displays the operable time meter 48a on the touch panel 26 based on the acquired remaining time information (P2-4). When the evolution-unlocked turn starts, the animation of extending the black part over the entire circumference is performed (FIGS. 13A and 13B).

The card battle game execution control unit 301a receives the card information determined by lottery from the cards in the deck region 45a in the server 1000(P2-5). The display control unit 302a recognizably arranges (displays) the card determined based on the received card information in the hand-of-cards region 46a (P2-5).

When the play point information is updated in the server 1000, the card battle game execution control unit 301a receives the updated play point information (P2-6). The display control unit 302a updates and displays the play point display portion 49a based on the received play point information (P2-6). As a result, one is added to the play points at the start of the turn.

When the evolution/super evolution point information is updated in the server 1000, the card battle game execution control unit 301a receives the updated evolution/super evolution point information (P2-7). The display control unit 302a updates and displays the evolution/super evolution point display region 44a based on the received evolution/super evolution point information (P2-7).

### When the Ability Activation Information

indicating that the abilities of the various cards are activated is newly set in the server 1000, the card battle game execution control unit 301a receives the ability activation information (P2-8). The card battle game execution control unit 301a performs ability activation processing of activating various abilities based on the received ability activation information (P2-9).

The card battle game execution control unit 301a determines whether an operation of playing a card is input by the player (P2-10). As a result, when the play operation is not detected (NO in P2-10), the card battle game execution control unit 301a shifts the processing to step P2-13. When the play operation is detected (YES in P2-10), the card battle game execution control unit 301a transmits the play information, to the server 1000, indicating that the card arranged in the hand-of-cards region 46a is brought out to the area 47a (P2-11). The display control unit 302a executes play card display processing of displaying that the card arranged in the hand-of-cards region 46a in the area 47a (P2-12). Further, here, in a case that the turn is a turn of the super evolution-unlocked turn number or after, the player possesses the super evolution point, and the follower card arranged in the area 47a can execute the super evolution, the display control unit 302a displays the effect image for the follower card (FIG. 16A).

The card battle game execution control unit 301a determines whether an operation is input by the player that the card arranged in the area 47a attacks the follower card or leader 41b of the opponent (P2-13). As a result, when the attack operation is not detected (NO in P2-13), the processing is shifted to step P2-16. When the attack operation is detected (YES in P2-13), the card battle game execution control unit 301a transmits, to the server 1000, the attack information including information for identifying the attacking card and information for identifying the attacked follower card or leader 41b of the opponent, based on the detected attack operation (P2-14).

The card battle game execution control unit 301a receives the attack result information set in the server (P2-15). The attack result information includes information indicating a result of subtraction of the physical strength of the attacked follower card or leader 41b of the opponent, information indicating a result of subtraction of the physical strength of the attacking follower card, and the like. In addition, the display control unit 302a performs various animations in case of attacking based on the received attack result information.

The card battle game execution control unit 301a determines whether a predetermined evolution possible condition is satisfied and whether a predetermined super evolution possible condition is satisfied for all the follower cards displayed in the area 47a (P2-16). In the present embodiment, the evolution possible condition is determined to be satisfied when the player possesses the evolution point or the super evolution point in or after the evolution-unlocked turn, and the card to be determined is a follower card capable of evolution. In addition, the evolution possible condition is determined to be satisfied when the player possesses the super evolution point in or after the super evolution-unlocked turn, and the card to be determined is a follower card capable of super evolution. Note that the present embodiment describes a case that the player terminal 1 makes a determination on whether the evolution possible condition and the super evolution possible condition are satisfied for all the follower cards displayed in the area 47a in P2-16, but the server 1000 may make the determination.

The card battle game execution control unit 301a determines whether the card displayed in the area 47a is tapped (P2-17). When the card is tapped (YES in P2-17), the display control unit 302a displays the card detail tab 63 based on the determination result in step P2-16 (P2-18). To be specific, when the evolution possible condition has been determined to be satisfied for the tapped card, the display control unit 302a validates (sets to an operable state) and displays the evolution button 63a in the card detail tab 63. When the super evolution possible condition has been determined to be satisfied for the tapped card, the display control unit 302a validates (sets to an operable state) and displays the super evolution button 63b in the card detail tab 63.

The card battle game execution control unit 301a performs evolution/super evolution execution processing (P4). The evolution/super evolution execution processing (P4) is described in detail later.

The display control unit 302a executes update processing of gradually decreasing the black part of the operable time meter 48a as time elapses (P2-19). However, the display control unit 302a may acquire the remaining time of the operable time from the server 1000 and update and display the operable time meter 48a based on the acquired remaining time of the operable time.

When the card battle game execution control unit 301a receives the winning/losing information from the server 1000, that is, when winning or losing is decided (YES in P2-20), the card battle game execution control unit 301a terminates the own turn control processing. When the card battle game execution control unit 301a does not receive the winning/losing information from the server 1000, that is, when winning or losing is not decided (NO in P2-20), the card battle game execution control unit 301a shifts the processing to P2-21.

The card battle game execution control unit 301a determines whether the player's turn ends in response to an operation by the player on the turn end button 48 (P2-21). When the player's turn does not end (NO in P2-21), the card battle game execution control unit 301a shifts the processing to P2-6.

When the player's turn ends (YES in P2-21), the display control unit 302a hides the operable time meter 48a based on the player's turn ending (P2-22).

The card battle game execution control unit 301a performs turn end processing (P2-23). Note that when there is a card having the ability 55 to be activated at the end of the player's turn, in the turn end processing, information is received from the server 1000 and processing of activating the ability 55 is performed. The card battle game execution control unit 301a transmits the turn end information indicating that the player's turn has ended to the server 1000.

FIG. 23 is a flowchart illustrating an example of the evolution/super evolution execution processing in the player terminal 1. The card battle game execution control unit 301a determines whether the evolution button 63a of the card detail tab 63 is tapped (P4-1). As a result, when the evolution button 63a is tapped (YES in P4-1), the card battle game execution control unit 301a shifts the processing to step P4-6.

When the evolution button 63a is not tapped (NO in P4-1), the card battle game execution control unit 301a determines whether the super evolution button 63b of the card detail tab 63 is tapped (P4-2).

When the super evolution button 63b is tapped (YES in P4-2), the card battle game execution control unit 301a transmits the evolution information (super evolution) indicating the card to be super-evolved to the server 1000 (P4-3).

The display control unit 302a stops the subtraction display of the operable time meter 48a for the second time (P4-4), displays the super evolution animation on the touch panel 26 for the second time (P4-5), and shifts the processing to step P5-10.

When the evolution button 63a is tapped (YES in P4-1), the card battle game execution control unit 301a transmits the evolution information (evolution) indicating the card to be evolved to the server 1000 (P4-6).

The display control unit 302a stops the subtraction display of the operable time meter 48a for the first time (P4-7), displays the evolution animation on the touch panel 26 for the first time (P4-8), and shifts the processing to step P4-9.

The card battle game execution control unit 301a determines whether the number of evolution points possessed by the player is less than one (P4-9). As a result, when the number of evolution points possessed by the player is not less than one, that is, when the player possesses any evolution point (NO in P4-9), the card battle game execution control unit 301a shifts the processing to step P4-11. As a result, when the number of the evolution points possessed by the player is less than one (YES in P4-9), the card battle game execution control unit 301a shifts the processing to step P4-10.

The card battle game execution control unit 301a transmits the super evolution point consumption operation information indicating the consuming of the super evolution point to the server 1000 (P4-10). That is, in the present embodiment, when the super evolution point is consumed and the super evolution is executed, and when the super evolution point is consumed and the evolution is executed, the super evolution point consumption operation information is transmitted to the server 1000.

The card battle game execution control unit 301a transmits the evolution point consumption operation information indicating the consuming of the evolution point to the server 1000 (P4-11). That is, in the present embodiment, when the evolution point is consumed and the evolution is executed, the evolution point consumption operation information is transmitted to the server 1000.

The card battle game execution control unit 301a receives the evolution/super evolution point information updated in the server 1000 (P4-12). The display control unit 302a performs the display update processing of changing the display mode of the icon image in the evolution/super evolution point display region 44a according to the number of evolution points and the number of super evolution points possessed by the player based on the received evolution/super evolution point information (P4-13).

The card battle game execution control unit 301a increases and updates the performances (e.g., attack power and physical strength) of the card to be evolved or super-evolved based on the operation of the player (P4-14). That is, when the evolution button 63a is tapped, update to the post-evolution performance of the card selected by the player is performed. Further, when the super evolution button 63b is tapped, update to the post-super evolution performance of the card selected by the player is performed.

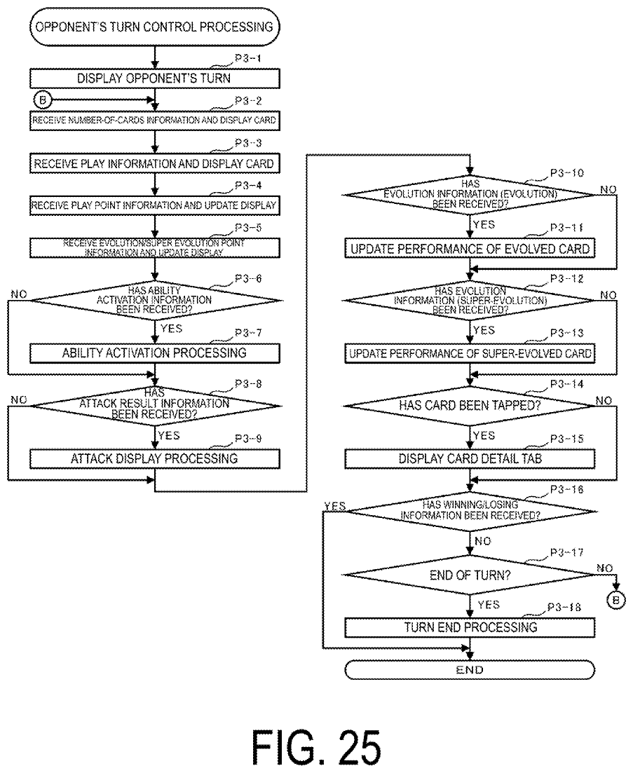

FIG. 25 is a flowchart illustrating an example of opponent's turn control processing (P3) in the player terminal 1. When the opponent's turn starts, the display control unit 302a displays, on the touch panel 26, an image showing “ENEMY TURN” that announces the opponent's turn (P3-1) as illustrated in FIG. 11B. The card battle game execution control unit 301a adds one to the play points of the opponent (P3-2). The display control unit 302a updates and displays the play point display portion 49b.

The display control unit 302a, once receiving the number-of-cards information, unrecognizably arranges the cards in the hand region 46b of the opponent based on the received number-of-cards information (P3-2).

The display control unit 302a, once receiving the play information, recognizably displays the card in the area 47b of the opponent based on the received play information (P3-3).

The card battle game execution control unit 301a, once receiving the play point information of the opponent, updates and displays the play point display portion 49b based on the received play point information (P3-4).

The display control unit 302a, once receiving the evolution/super evolution point information, updates and displays display of the evolution/super evolution point display region 44b based on the received evolution/super evolution point information (P3-5).

The card battle game execution control unit 301a determines whether the ability activation information is received (P3-6). When the ability activation information is received (YES in P3-6), the display control unit 302a performs the ability activation processing of activating various abilities based on the received ability activation information (P3-7).

The card battle game execution control unit 301a determines whether the attack result information is received (P3-8). When the attack result information is received (YES in P3-8), the display control unit 302a performs various animations in case of attacking executed based on the received attack result information (P3-9).

The card battle game execution control unit 301a determines whether the evolution information (evolution) is received (P3-10). When the evolution information (evolution) is received (YES in P3-10), the card battle game execution control unit 301a refers to the received evolution information (evolution) and the card management information, and increases and updates the performances (e.g., attack power and physical strength) of the follower card to be evolved (P3-11).

The card battle game execution control unit 301a determines whether the evolution information (super evolution) is received (P3-12). When the evolution information (super evolution) is received (YES in P3-12), the card battle game execution control unit 301a refers to the received evolution information (super evolution) and the card management information, and increases and updates the performances (e.g., attack power and physical strength) of the follower card to be evolved (P3-13).

The card battle game execution control unit 301a determines whether the card displayed in the area 47a is tapped (P3-14). When the card is tapped (YES in P3-14), the display control unit 302a displays the card detail tab 63 (P3-15). In this case, since the opponent's turn is in progress, the display control unit 302a invalidates (sets to an inoperable state) and displays the evolution button 63a and the super evolution button 63b in the card detail tab 63.

When the card battle game execution control unit 301a receives the winning/losing information from the server 1000, that is, when winning or losing is decided (YES in P3-16), the card battle game execution control unit 301a terminates the opponent's turn control processing. When the card battle game execution control unit 301a does not receive the winning/losing information from the server 1000, that is, when winning or losing is not decided (NO in P3-16), the card battle game execution control unit 301a shifts the processing to P3-17.

The card battle game execution control unit 301a determines whether the turn end information is received (P3-17). When the turn end information is not received (NO in P3-17), the card battle game execution control unit 301a shifts the processing to step P3-2. When the turn end information is received (YES in P3-17), the card battle game execution control unit 301a performs the turn end processing (P3-18). Note that when there is a card having the ability 55 to be activated at the end of the opponent's turn, in the turn end processing, the ability activation information is received from the server 1000 and processing of activating the ability 55 is performed.

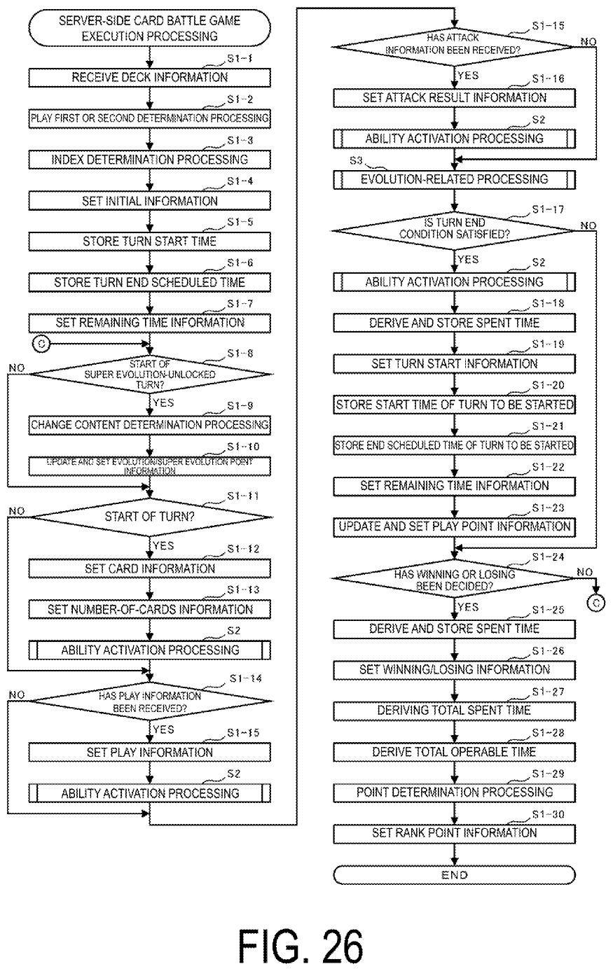

FIG. 26 is a flowchart illustrating an example of server-side card battle game execution processing (S1) in the server 1000. When the server-side card battle game execution processing is initiated, the card battle game execution control unit 1301a receives the deck information from the player terminal 1 of the player and the player terminal 1 of the opponent (S1-1). Then, the card battle game execution control unit 1301a determines the play order (S1-2), assigns indices to cards included in the deck information (S1-3), and sets the initial information so as to be acquirable by the player terminal 1 of the player and the player terminal 1 of the opponent (S1-4).

Note that, when the player plays first, the card battle game execution control unit 1301a gives three evolution points to the player, gives four evolution points to the opponent, and sets the evolution/super evolution points based on a result of the giving of the points in the initial information. When the player plays second, the card battle game execution control unit 1301a gives four evolution points to the player, gives three evolution points to the opponent, and sets the evolution/super evolution points based on a result of the giving of the points in the initial information.

When the player plays first, the card battle game execution control unit 1301a sets in the initial information the evolution/super evolution turn information indicating that the evolution-unlocked turn of the player is the fifth turn, the evolution-unlocked turn of the opponent is the fourth turn, the super evolution-unlocked turn of the player is the seventh turn, and the super evolution-unlocked turn of the opponent is the sixth turn. When the player plays second, the card battle game execution control unit 1301a sets in the initial information the evolution/super evolution turn information indicating that the evolution-unlocked turn of the player is the fourth turn, the evolution-unlocked turn of the opponent is the fifth turn, the super evolution-unlocked turn of the player is the sixth turn, and the super evolution-unlocked turn of the opponent is the seventh turn.

The time management unit 1303a stores the turn start time (S1-5). To be more specific, when the player's turn starts, the time management unit 1303a stores the turn start time in association with the player ID. When the opponent's turn starts, the time management unit 1303a stores the turn start time in association with the player ID of the opponent.

The time management unit 1303a stores the turn end scheduled time (S1-6). To be more specific, when the player's turn starts, the time management unit 1303a stores the turn end scheduled time, which is the time obtained by adding the operable time set for the started turn, in association with the player ID. When the opponent's turn starts, the time management unit 1303a stores the turn end scheduled time in association with the player ID of the opponent.

In addition, when the player's turn starts, the time management unit 1303a sets the operable time set for the started turn, that is, the remaining time information indicating the remaining time, to be acquirable to the player terminal 1 (S1-7). When the opponent's turn starts, the time management unit 1303a sets the remaining time information is set to be acquirable to the player terminal 1 of the opponent (S1-7).

The card battle game execution control unit 1301a determines whether the super evolution-unlocked turn of the player or the super evolution-unlocked turn of the opponent starts (S1-8). As a result, when the super evolution-unlocked turn of the player or the super evolution-unlocked turn of the opponent starts (YES in S1-8), the card battle game execution control unit 1301a shifts the processing to step S1-9. The card battle game execution control unit 1301a performs a change content determination processing (S1-9).

When the super evolution-unlocked turn number of the player is reached, the card battle game execution control unit 1301a determines to change up to two points of the evolution points possessed by the player to the super evolution point in the change content determination processing (S1-9). In this case, to be specific, when the evolution points possessed by the player are two or more points, the card battle game execution control unit 1301a determines to change two evolution points to two super evolution points and give the super evolution points to the player ID. When the evolution points possessed by the player are one point, the card battle game execution control unit 1301a determines to change one evolution point to one super evolution point and give the super evolution point to the player ID. Note that when the evolution points possessed by the player are zero points, the card battle game execution control unit 1301a determines not to execute the change to the super evolution point.

When the super evolution-unlocked turn number of the opponent is reached, the card battle game execution control unit 1301a determines to change up to two points of the evolution points possessed by the opponent to the super evolution point in the change content determination processing (S1-9). In this case, to be specific, when the evolution points possessed by the opponent are two or more points, the card battle game execution control unit 1301a determines to change two evolution points to two super evolution points and give the super evolution points to the player ID of the opponent. When the evolution points possessed by the opponent are one point, the card battle game execution control unit 1301a determines to change one evolution point to one super evolution point and give the super evolution point to the player ID of the opponent. Note that when the evolution points possessed by the opponent are zero points, the card battle game execution control unit 1301a determines not to execute the change to the super evolution point.

When the super evolution points are given to the player through the change content determination processing described above (S1-9), the card battle game execution control unit 1301a updates the evolution/super evolution point information indicating the number of evolution points and the number of the super evolution points possessed by the player (S1-10). When the super evolution points are given to the opponent through the change content determination processing described above (S1-9), the card battle game execution control unit 1301a updates the evolution/super evolution point information indicating the number of evolution points and the number of the super evolution points possessed by the opponent (S1-10). Then, the card battle game execution control unit 1301a sets the updated evolution/super evolution point information to be acquirable to the player terminal 1 of the player and the player terminal 1 of the opponent (S1-10).

The card battle game execution control unit 1301a determines whether it is the time of the start of the player's turn or the opponent's turn (S1-11). When it is not the time of the start of the player's turn or the opponent's turn (NO in S1-11), the card battle game execution control unit 1301a shifts the processing to step S1-14.

When it is the time of the start of the player's turn (YES in S1-11), the card battle game execution control unit 1301a determines one card by lottery from the cards arranged in the deck region 45a of the player, and sets the card information indicating the determined card to be acquirable to the player terminal 1 (S1-12). In addition, the number-of-cards information is set to be acquirable to the player terminal 1 of the opponent (S1-13).

When it is the time of the start of the opponent's turn (YES in S1-11), the card battle game execution control unit 1301a determines one card by lottery from the cards arranged in the deck region 45b of the opponent, and sets the card information indicating the determined card to be acquirable to the player terminal 1 of the opponent (S1-12). In addition, the number-of-cards information is set to be acquirable to the player terminal 1 (S1-13). The card battle game execution control unit 1301a performs the ability activation processing (S2). The ability activation processing (S2) is described in detail later.

The card battle game execution control unit 1301a determines whether the play information is received (S1-14). When the play information is not received (NO in S1-14), the card battle game execution control unit 1301a shifts the processing to step S1-15. When the play information is received (YES in S1-14), the card battle game execution control unit 1301a sets the play information to be acquirable to the player terminal 1 of the opponent, which is different from the player terminal 1 receiving the play information (S1-15). The card battle game execution control unit 1301a performs the ability activation processing (S2) described later.

The card battle game execution control unit 1301a determines whether the attack information is received (S1-15). When the attack information is not received (NO in S1-15), the card battle game execution control unit 1301a shifts the processing to step S3. When the attack information is received (YES in S1-15), the card battle game execution control unit 1301a sets the attack result information to be acquirable to the player terminal 1 of the opponent, which is different from the player terminal 1 receiving the attack information, the attack result information including information indicating a result of subtraction of the physical strength of the attacked follower card or the leader 41a or 41b, information indicating a result of subtraction of the physical strength of the attacking follower card, and the like (S1-16). The card battle game execution control unit 1301a performs the ability activation processing (S2) described later.

The card battle game execution control unit 1301a performs evolution-related processing (S3). The evolution-related processing (S3) is described in detail later.

The card battle game execution control unit 1301a determines whether a predetermined turn end condition is satisfied (S1-17). In the present embodiment, the card battle game execution control unit 1301a determines that the turn end condition is satisfied when the player or the opponent taps the turn end button 48 or when the turn end scheduled time is reached.

As a result, when the turn end condition is not satisfied (NO in S1-17), the card battle game execution control unit 1301a shifts the processing to step S1-24. When the turn end condition is satisfied (YES in S1-17), the card battle game execution control unit 1301a performs the ability activation processing (S2) described later.

The time management unit 1303a derives and stores a spent time in the ended turn based on an elapsed time from the turn start time at the time point of the turn ending (S1-18). Note that when the evolution is executed during the turn, the time management unit 1303a derives, as the spent time, a time obtained by subtracting the first time from the elapsed time from the turn start time at the time point of the turn ending. When the super evolution is executed during the turn, the time management unit 1303a derives, as the spent time, a time obtained by subtracting the second time from the elapsed time from the turn start time at the time point of the turn ending.

When the player's turn ends, the card battle game execution control unit 1301a sets the turn end information and the turn start information to be acquirable to the player terminal 1 of the opponent (S1-19). When the opponent's turn ends, the card battle game execution control unit 1301a sets the turn end information and the turn start information to be acquirable to the player terminal 1 (S1-19).

The time management unit 1303a stores the turn start time of the turn to be started (S1-20). The time management unit 1303a stores the turn end scheduled time of the turn to be started (S1-21). The time manager 1303a sets the remaining time information indicating the operable time of the started turn, that is, the remaining time (S1-22).

The card battle game execution control unit 1301a updates the play point information to add one to the play points of the player of which turn starts or the opponent (S1-23). The card battle game execution control unit 1301a sets the updated play point information so as to be acquirable by the player terminal 1 of the player and the player terminal 1 of the opponent.

The card battle game execution control unit 1301a determines whether winning or losing is decided, that is, whether the physical strength of the leader 41a of the player or the physical strength of the leader 41b of the opponent becomes 0 (S1-24). Note that the conditions for deciding winning or losing may include conditions other than the condition that the physical strength of the leader 41a or the leader 41b is 0. For example, winning/losing may be decided based on all the cards in the deck region 45a or the deck region 45b are used up, that is, running out in the deck. Alternatively, winning or losing may be decided based on special cards placed at the bottoms of the deck region 45a and the deck region 45b being drawn. Alternatively, winning or losing may be decided based on a special condition set in advance other than the above being satisfied. For example, the special condition may be satisfied when the ability 55 of a card in which the special ability 55 for deciding winning or losing is set is activated. As a result, when winning or losing is not decided (NO in S1-24), the card battle game execution control unit 1301a shifts the processing to step S1-8.

When winning or losing is decided (YES in S1-24), the time management unit 1303a derives and stores a spent time in the ended turn based on an elapsed time from the turn start time at the time point of winning or losing being decided (S1-25). Note that when the evolution is executed during the turn, the time management unit 1303a derives, as the spent time, a time obtained by subtracting the first time from the elapsed time from the turn start time at the time point of the turn ending. When the super evolution is executed during the turn, the time management unit 1303a derives, as the spent time, a time obtained by subtracting the second time from the elapsed time from the turn start time at the time point of the turn ending.

The card battle game execution control unit 1301a sets the winning/losing information indicating that winning or losing is decided and a winner to be acquirable to the player terminal 1 of the player and the player terminal 1 of the opponent (S1-26).

The time management unit 1303a derives a total spent time obtained by summing up all the spent times of the player until the turn in which winning or losing is decided, and stores the total spent time in association with the player ID (S1-27). Further, the time management unit 1303a derives a total spent time obtained by summing up all the spent times of the opponent until the turn in which winning or losing is decided, and stores the total spent time in association with the player ID of the opponent (S1-27).

The time management unit 1303a derives a total operable time obtained by summing up all the operable times of the player until the turn in which winning or losing is decided, and stores the total operable time in association with the player ID (S1-28). Further, the time management unit 1303a derives a total operable time obtained by summing up all the operable times of the opponent until the turn in which winning or losing is decided, and stores the total operable time in association with the player ID of the opponent (S1-28).

The rank point management unit 1304a determines a rank point to be given to the player ID of the player and a rank point to be given to the player ID of the opponent based on the values derived in steps S1-18, S1-25, S1-27, and S1-28 described above, and the execution content and the execution result of the card battle game (S1-29). The rank point management unit 1304a gives the determined rank point to the player ID of the player and the player ID of the opponent.

The rank point management unit 1304a sets the corresponding rank point information to be acquirable to the player terminal 1 of the player and the player terminal 1 of the opponent (S1-30), and terminates the server-side card battle game execution processing.

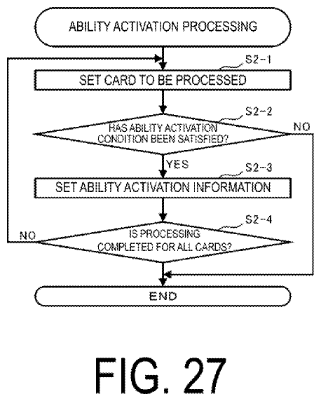

FIG. 27 is a flowchart illustrating an example of the ability activation processing (S2) in the server 1000. The card battle game execution control unit 1301a sets a card to be processed from among the card displayed in the area 47a or 47b, the card having made an attack, and the evolved or super-evolved card (S2-1). The card battle game execution control unit 1301a determines whether a condition for activating the ability is satisfied for the card to be processed set in step S2-1 (S2-2). As a result, when the ability activation condition is not satisfied (NO in S2-2), the card battle game execution control unit 1301a terminates the ability activation processing.

When the ability activation condition is satisfied (YES in S2-2), the card battle game execution control unit 1301a sets the ability activation information indicating that the ability for which the activation condition is satisfied to be acquirable to the player terminal 1 of the player and the player terminal 1 of the opponent (S2-3).

The card battle game execution control unit 1301a determines whether the processing in steps S2-1 to S2-3 described above is performed for each of the card displayed in the area 47a or 47b, the card having made an attack, and the evolved or super-evolved card (S2-4). As a result, when the processing is performed for all the cards (YES in S2-4), the card battle game execution control unit 1301a terminates the ability activation processing. When the processing is not performed for all the cards (NO in S2-4), the card battle game execution control unit 1301a shifts the processing to step S2-1.

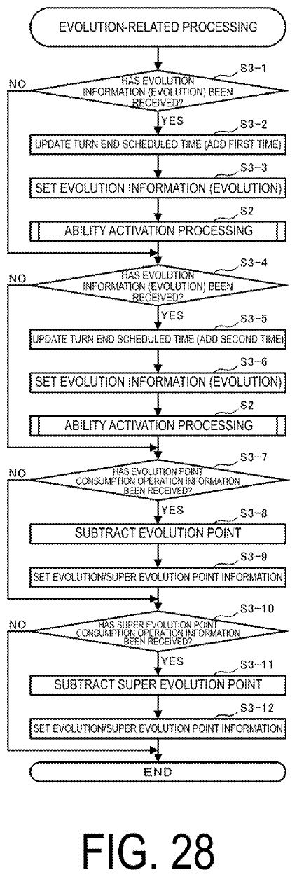

FIG. 28 is a flowchart illustrating an example of the evolution-related processing (S3) in the server 1000. The card battle game execution control unit 1301a determines whether the evolution information (evolution) is received (S3-1). When the evolution information (evolution) is not received (NO in S3-1), the card battle game execution control unit 1301a shifts the processing to step S3-4. When the evolution information (evolution) is received (YES in S3-1), the time management unit 1303a updates the turn end scheduled time (S3-2). To be specific, the time management unit 1303a stores a time obtained by adding the first time (for example, two seconds) to the turn end scheduled time as a new turn end scheduled time.

The card battle game execution control unit 1301a sets the evolution information (evolution) to be acquirable to the player terminal 1 of the opponent, which is different from the player terminal 1 receiving the evolution information (evolution) (S3-3). The card battle game execution control unit 1301a performs the ability activation processing (S2).

The card battle game execution control unit 1301a determines whether the evolution information (super evolution) is received (S3-4). When the evolution information (super evolution) is not received (NO in S3-4), the card battle game execution control unit 1301a shifts the processing to step S3-7. When the evolution information (super evolution) is received (YES in S3-4), the time management unit 1303a updates the turn end scheduled time (S3-5). To be specific, the time management unit 1303a stores a time obtained by adding the second time (for example, three seconds) to the turn end scheduled time as a new turn end scheduled time.

The card battle game execution control unit 1301a sets the evolution information (super evolution) to be acquirable to the player terminal 1 of the opponent, which is different from the player terminal 1 receiving the evolution information (super evolution) (S3-6). The card battle game execution control unit 1301a performs the ability activation processing (S2).

The card battle game execution control unit 1301a determines whether the evolution point consumption operation information is received from the player terminal 1 of the player or the player terminal 1 of the opponent (S3-7). As a result, when the evolution point consumption operation information is not received (NO in S3-7), the card battle game execution control unit 1301a shifts the processing to step S3-10.

When the evolution point consumption operation information is received from the player terminal 1 (YES in S3-7), the card battle game execution control unit 1301a subtracts the evolution point possessed by the player (S3-8), and sets the evolution/super evolution point of the player based on the result of the subtraction to be acquirable to the player terminal 1 of the player and the player terminal 1 of the opponent (S3-9).

When the evolution point consumption operation information is received from the player terminal 1 of the opponent (YES in S3-7), the card battle game execution control unit 1301a subtracts the evolution point possessed by the opponent (S3-8), and sets the evolution/super evolution point of the opponent based on the result of the subtraction to be acquirable to the player terminal 1 of the player and the player terminal 1 of the opponent (S3-9).

The card battle game execution control unit 1301a determines whether the super evolution point consumption operation information is received from the player terminal 1 of the player or the player terminal 1 of the opponent (S3-10). As a result, when the super evolution point consumption operation information is not received (NO in S3-10), the card battle game execution control unit 1301a terminates the evolution-related processing.

When the super evolution point consumption operation information is received from the player terminal 1 (YES in S3-10), the card battle game execution control unit 1301a subtracts the super evolution point possessed by the player (S3-11), and sets the evolution/super evolution point of the player based on the result of the subtraction to be acquirable to the player terminal 1 of the player and the player terminal 1 of the opponent (S3-12).

When the super evolution point consumption operation information is received from the player terminal 1 of the opponent (YES in S3-10), the card battle game execution control unit 1301a subtracts the super evolution point possessed by the opponent (S3-11), and sets the evolution/super evolution point of the opponent based on the result of the subtraction to be acquirable to the player terminal 1 of the player and the player terminal 1 of the opponent (S3-12).

As described above, the player terminal 1 is provided with the game execution control program 300, the card battle game execution program 301, and the display control program 302. The player terminal 1 includes the game execution control unit 300a, the card battle game execution control unit 301a, and the display control unit 302a. However, some or all of these programs and functional units may be provided to the server 1000. That is, these programs and functional units may be provided to one or both of the player terminal 1 and the server 1000.

The server 1000 is provided with the game execution control program 1300, the card battle game execution control program 1301, the time management program 1303, and the rank point management program 1304. The server control unit 1000 includes the game execution control unit 1300a, the card battle game execution control unit 1301a, the time management unit 1303a, and the rank point management unit 1304a. However, some or all of these programs and functional units may be provided to the player terminal 1. That is, these programs and functional units may be provided to one or both of the player terminal 1 and the server 1000.

Here, an aspect of the embodiment has been described with reference to the accompanying drawings. However, it goes without saying that the present invention is not limited to the above-described embodiment. It is apparent to those skilled in the art that various modifications and corrections can be made within the scope of the claims, and it should be understood that such modifications and corrections also obviously fall within the technical scope of the present invention.

Although the digital card game has been described as an example in the above-described embodiment, genres and contents of the game are not particularly limited, and include a simulation game, a mah-jongg game, a baseball game, and a sugoroku (or snakes and ladders) game, for example. In any case, the game may be a turn-based game using a game medium. The opponent is not limited to a person, and may be a computer. Thus, the game media are not limited to digital cards, and are any game media provided in a game, such as characters, units, or pieces. The game is not limited to a match-up game. For example, the game may be a turn-based game in which a plurality of players sequentially take over the result of the previous player.

In the above-described embodiment, the information processing system S, which is a client server system, performs the above-described information processing. However, the function of the server 1000 in the above-described embodiment may be provided to the player terminal 1. The function of the player terminal 1 in the above-described embodiment may be provided to the server 1000. The communication function is not essential, and for example, a match-up against a computer or a match-up between a plurality of players may be executable in the game apparatus G. In any case, the information processing program suitably causes a computer to execute the following processing.

### Processing Executed by Computer

Processing of progressing a game including a plurality of turns (in the above embodiment, the card battle game as an example) (in the above embodiment, step P1, P2, P3, P4, S1, S2, or S3 as an example).

Process of determining the spent time of the player in each turn based on the turn ending (in the above embodiment, step S1-18 or S1-25 as an example).

Processing of determining first points (in the above embodiment, the rank point corresponding to the item “battle win” as an example) based on a result of the game (in the above embodiment, step S1-29 as an example).

Processing of determining a second point (in the above embodiment, the rank point corresponding to the item “play time” as an example) based on at least the spent time (in the above embodiment, step S1-29 as an example).

Processing of giving a reward (in the above embodiment, the total sum of the rank points corresponding to the respective items in FIG. 17 as an example) to a player ID based on the first points and the second points (in the above embodiment, step S1-29 or S1-30 as an example).

The computer may be caused to execute processing of determining a total spent time taken until the game is ended based on the spent time (in the above embodiment, step S1-27 as an example).

The computer may be caused to execute processing of determining an operable time of the player in each turn (in the above embodiment, step S1-6, S1-7, S1-21, or S1-22 as an example).

The computer may be caused to execute processing of determining a total operable time that is a sum of the operable times in the respective turns executed until the game is ended, (in the above embodiment, step S1-28 as an example).

The processing of determining the second point (in the above embodiment, step S1-29 as an example) may include determining the second point based on a ratio of the total spent time to the total operable time.

The processing of determining the second point (in the above embodiment, step S1-29 as an example) may include determining the second point based on a ratio of the spent time to the operable time in each of the turns executed until the game is ended.

The plurality of turns different from each other in the operable time may be included (in the above embodiment, the operable time is different between the turn before the evolution-unlocked turn and the turn of or after the evolution-unlocked turn, as an example).

The plurality of turns may include the turn of the player and the turn of an opponent.

The processing of determining the spent time (in the above embodiment, S1-18 or S1-25 as an example) may include determining the spent time of the player in the turn of the player when the turn of the player ends, and determining the spent time of the player in the turn of the opponent when the turn of the opponent ends and the player performs an operation in the turn of the opponent.

The control processing described in the above embodiment is merely an example. In the above-described embodiment, a case has been described in which the control processing for executing the game is executed in the player terminal 1. That is, in the above embodiment, the control processing for executing the game is executed only in the player terminal 1. In this case, only the player terminal 1 functions as the game apparatus G. However, a part of the control processing described above may be executed in the server 1000. That is, the information processing system S, which is a client-server system including the player terminal 1 and the server 1000, may function as the game apparatus G.

In the above-described embodiment, the information processing program for implementing the game may be stored in a non-transitory computer-readable storage medium. In addition, the above-described embodiment may correspond to an information processing method for implementing each function and the steps illustrated in the flowcharts.

What is claimed is:

1. A non-transitory computer readable medium storing a program causing a computer to execute:
processing of progressing a game including a plurality of turns;
processing of determining time spent by a player in a corresponding turn among the plurality of turns, based on the corresponding turn ending;
processing of determining first points based on a result of the game;
processing of determining second points based on at least the spent time; and
processing of giving a reward to a player ID based on the first points and the second points.

2. The non-transitory computer readable medium according to claim 1, wherein the program further causes the computer to execute:
processing of determining a total spent time taken until the game is ended, based on the spent time;
processing of determining an operable time of the player in each of the plurality of turns; and
processing of determining a total operable time that is a sum of the operable time in each of the plurality of turns executed until the game is ended, wherein
the processing of determining the second points includes determining the second points based on a ratio of the total spent time to the total operable time.

3. The non-transitory computer readable medium according to claim 1, wherein the program further causes the computer to execute:
processing of determining an operable time of the player in each of the plurality of turns, wherein
the processing of determining the second points includes determining the second points based on a ratio of the spent time to the operable time in each of the plurality of turns executed until the game is ended.

4. The non-transitory computer readable medium according to claim 2, wherein
the plurality of turns include two or more turns that are different from each other in the operable time.

5. The non-transitory computer readable medium according to claim 1, wherein
the plurality of turns include a turn of the player and a turn of an opponent, and
the processing of determining the spent time includes:
determining the spent time of the player in the turn of the player when the turn of the player ends; and
determining the spent time of the player in the turn of the opponent when the turn of the opponent ends and the player performs an operation in the turn of the opponent.

6. An information processing method executed by one or more computers, the information processing method comprising:
processing of progressing a game including a plurality of turns;
processing of determining time spent by a player in a corresponding turn among the plurality of turns based on the corresponding turn ending;
processing of determining first points based on a result of the game;
processing of determining second point based on at least the spent time; and
processing of giving a reward to a player ID based on the first points and the second points.

7. An information processing system comprising one or more computers, wherein
the one or more computers execute:
processing of progressing a game including a plurality of turns;
processing of determining time spent by a player in a corresponding turn among the plurality of turns based on the corresponding turn ending;
processing of determining first points based on a result of the game;
processing of determining second points based on at least the spent time; and
processing of giving a reward to a player ID based on the first points and the second points.

8. A game apparatus comprising one or more computers, wherein
the one or more computers execute:
processing of progressing a game including a plurality of turns;
processing of determining time spent by a player in a corresponding turn among the plurality of turns based on the corresponding turn ending;
processing of determining first points based on a result of the game;
processing of determining second points based on at least the spent time; and
processing of giving a reward to a player ID based on the first points and the second points.
